(19) United States
(12) Patent Application Publication
(10) Pub. No.: US 2026/0004419 A1
(43) Pub. Date: Jan. 1, 2026

(54) IMAGE INSPECTION APPARATUS, IMAGE FORMING APPARATUS, AND IMAGE INSPECTION METHOD

(71) Applicants: Kota AOYAGI, Tokyo (JP); Takuji KAMADA, Tokyo (JP); Keiji KOJIMA, Tokyo (JP); Wataru NARA, Tokyo (JP); UMEMURA Educational Institutions, Nagoya-shi (JP)

(72) Inventors: Kota AOYAGI, Tokyo (JP); Kimiya AOKI, Nagoya-shi (JP); Takuji KAMADA, Tokyo (JP); Keiji KOJIMA, Tokyo (JP); Wataru NARA, Tokyo (JP)

(73) Assignees: Ricoh Company, Ltd., Tokyo (JP); UMEMURA Educational Institutions, Nagoya-shi (JP)

(21) Appl. No.: 19/241,286

(22) Filed: Jun. 17, 2025

(30) Foreign Application Priority Data
Jun. 28, 2024 (JP) 2024-105122

(51) Int. Cl. G06T 7/00; G06K 15/02; G06T 7/11

(52) U.S. Cl. CPC G06T 7/001; G06K 15/027; G06T 7/11; G06T 2207/20021; G06T 2207/20216; G06T 2207/30144

(57) ABSTRACT

An image inspection apparatus for inspecting a defect of an inspection object is disclosed. The image inspection apparatus includes an imager configured to capture an inspection image of the inspection object; and a processor configured to process the inspection image captured by the imager. The processing the inspection image by the processor includes generating a sensitivity map image which has the same size as the inspection image and a non-defective image and in which a detection threshold is set for each predetermined detection region, and detecting a defect region using the sensitivity map image.

### CROSS-REFERENCE TO RELATED APPLICATION

The present application claims priority under 35 U.S.C. § 119 to Japanese Patent Application No. 2024-105122, filed on Jun. 28, 2024, the contents of which are incorporated herein by reference in their entirety.

### BACKGROUND OF THE INVENTION

### 1. Field of the Invention

The present disclosure relates to an image inspection apparatus, an image forming apparatus, and an image inspection method.

### 2. Description of the Related Art

Japanese Patent No. 5821708 (Patent Document 1), for example, discloses a technology that extracts defective candidate regions by comparing the luminance values of surrounding pixels in a low-resolution divided image in order to inspect an abnormality of an inspection object at high speed and with high sensitivity. In addition, Japanese Patent No. 5678595 (Patent Document 2) discloses a technology that differentiates the detection threshold for defects between regions with large pixel value changes, such as patterns and edges, and regions with small pixel value changes, such as backgrounds, in order to increase the inspection accuracy of printed matter and other inspection objects.

### RELATED ART DOCUMENTS

### Patent Documents

Patent Document 1: Japanese Patent No. 5821708
Patent Document 2: Japanese Patent No. 5678595

### SUMMARY OF THE INVENTION

An image inspection apparatus according to one aspect of the present disclosure is an image inspection apparatus for inspecting a defect of an inspection object. The image inspection apparatus includes:
an imager configured to capture an inspection image of the inspection object;

a memory storing programs having computer-readable instructions; and
a processor configured to process the inspection image captured by the imager,
wherein the processing the inspection image by the processor includes:
   generating an inspection image divided image using a first inspection image processed image, the first inspection image processed image being obtained by averaging luminance values of pixels in each of a plurality of processing regions into which the inspection image is divided under a predetermined first inspection image dividing condition;
   generating a non-defective image divided image using a first non-defective image processed image, the first non-defective image processed image being obtained by averaging luminance values of pixels in each of a plurality of processing regions into which a non-defective image to be compared with the inspection image is divided under a predetermined first non-defective image dividing condition;
   generating a sensitivity map image which has a same size as the inspection image and the non-defective image and in which a detection threshold is set for each predetermined detection region;
   dividing the sensitivity map image into a plurality of regions according to the first inspection image dividing condition, and generating a first inspection image sensitivity image by processing a first inspection image threshold of each region according to the detection threshold;
   dividing the sensitivity map image into a plurality of regions according to the first non-defective image dividing condition, and generating a first non-defective image sensitivity image by processing a first non-defective image threshold of each region according to the detection threshold;
   comparing luminance values of pixels in an inspection image region of interest with luminance values of pixels in a processing region around the inspection image region of interest, from among a plurality of processing regions included the inspection image divided image, and extracting an inspection image defect candidate region based on the first inspection image threshold;
   comparing luminance values of pixels in a non-defective image region of interest with luminance values of pixels in a processing region around the non-defective image region of interest, from among a plurality of processing regions included in the non-defective image divided image, and extracting a non-defective image defect candidate region based on the first non-defective image threshold; and
   comparing the inspection image defect candidate region with the non-defective image defect candidate region to detect a defective region.

### BRIEF DESCRIPTION OF THE DRAWINGS

FIG. 1 is a diagram illustrating an example of the overall configuration of an image forming apparatus including an image inspection apparatus according to an embodiment.

FIG. 2 is a block diagram illustrating an example of a hardware configuration of the image forming apparatus including an image inspection apparatus according to the embodiment.

FIG. 3 is a diagram illustrating a configuration example of the image inspection apparatus according to the embodiment.

FIG. 4 is a block diagram illustrating an example of a functional configuration of a processor included in the image inspection apparatus according to a first embodiment.

FIG. 5 is a flowchart illustrating an operation of the image inspection apparatus according to the first embodiment.

FIG. 6 is a diagram illustrating an example of an inspection image.

FIG. 7 is a diagram illustrating an example of a processed image for a first inspection image.

FIG. 8 is a diagram illustrating an example of an inspection image defective candidate region image obtained from the first inspection image processed image of FIG. 7.

FIG. 9 is a diagram illustrating an example of a non-defective image.

FIG. 10 is a diagram illustrating an example of a first non-defective image processed image.

FIG. 11 is a diagram illustrating an example of a non-defective image defective candidate region obtained from the first non-defective image processed image of FIG. 10.

FIG. 12 includes diagrams illustrating a sensitivity map image and a first inspection image sensitivity image.

FIG. 13 is a diagram illustrating mean filter processing of the first inspection image sensitivity image.

FIG. 14 is a diagram illustrating maximum filter processing of the first inspection image sensitivity image.

FIG. 15 is a diagram illustrating minimum filter processing of the first inspection image sensitivity image.

FIG. 16 is a diagram illustrating median filter processing of the first inspection image sensitivity image.

FIG. 17 is a diagram illustrating a first example of a dead zone process of the first inspection image sensitivity image.

FIG. 18 is a diagram illustrating a second example of the dead zone processing of the first inspection image sensitivity image.

FIG. 19 is a diagram illustrating a third example of the dead zone processing of the first inspection image sensitivity image.

FIG. 20 is a diagram illustrating a first example of a relationship between a luminance value of the first inspection image sensitivity image and a detection threshold.

FIG. 21 is a diagram illustrating a second example of the relationship between the luminance value of the first inspection image sensitivity image and the detection threshold.

FIG. 22 is a diagram illustrating a third example of the relationship between the luminance value of the first inspection image sensitivity image and the detection threshold.

FIG. 23 is a block diagram illustrating an example of a functional configuration of a processor of an image inspection apparatus according to a second embodiment.

FIG. 24 is a flowchart illustrating an operation of the image inspection apparatus according to the second embodiment.

FIG. 25 is a diagram illustrating an example of a second inspection image processed image.

FIG. 26 is a diagram illustrating an example of an inspection image defective candidate region image obtained from the second inspection image processed image of FIG. 25.

FIG. 27 is a block diagram illustrating an example of a functional configuration of a processor of an image inspection apparatus according to a third embodiment.

FIG. 28 is a flowchart illustrating an operation example of the image inspection apparatus according to the third embodiment.

FIG. 29 is a diagram illustrating an example of a process by a processor provided in the image inspection apparatus according to the third embodiment.

FIG. 30 is a diagram illustrating a first voting defective region in the image inspection apparatus according to the third embodiment.

FIG. 31 is a diagram illustrating a second voting defective region in the image inspection apparatus according to the third embodiment.

### DESCRIPTION OF THE PREFERRED EMBODIMENTS

When the technology of Patent Document 1 is applied to the inspection of an inspection object that includes regions with large pixel value changes and regions with small pixel value changes, the defect detection threshold may not be set appropriately for low resolution images, and inspection accuracy may be reduced.

Thus, it is desirable to provide an image inspection apparatus and an image inspection method inspecting an inspection object at high capable of speed and with high accuracy.

According to the present disclosure, it is possible to provide an image inspection apparatus and an image inspection method capable of inspecting an inspection object at high speed and with high accuracy.

Hereinafter, embodiments of the present disclosure will be described with reference to the accompanying drawings. In the drawings, the same components are denoted by the same reference numerals, and redundant description will be appropriately omitted.

The embodiments described below are examples of an image inspection apparatus, an image forming apparatus, and an image inspection method for embodying the technical idea of the present disclosure, and the present disclosure is not limited to the embodiments described below. The shapes of the components, the relative arrangement thereof, the values of the parameters, and the like described below are not intended to limit the scope of the present disclosure thereto but are intended to exemplify the present disclosure unless otherwise specified. In addition, the size, positional relationship, and the like of members illustrated in the drawings may be exaggerated for clarity of description.

Hereinafter, a case where an image forming apparatus such as a commercial printing machine (production printing machine) that continuously prints a large number of sheets in a short time inspects a defect of a printed image printed on a recording medium such as a sheet by the image inspection apparatus according to the embodiment will be described as an example.

In the present specification, image formation and printing are synonymous. The printed image means a toner image formed on a recording medium. The recording medium on which the printed image is formed is referred to as an inspection object. An inspection image means an image of electronic data captured by the imager, and a non-defective image also means an image of electronic data.

### EMBODIMENTS

### <Overall Configuration of Image Forming Apparatus 1>

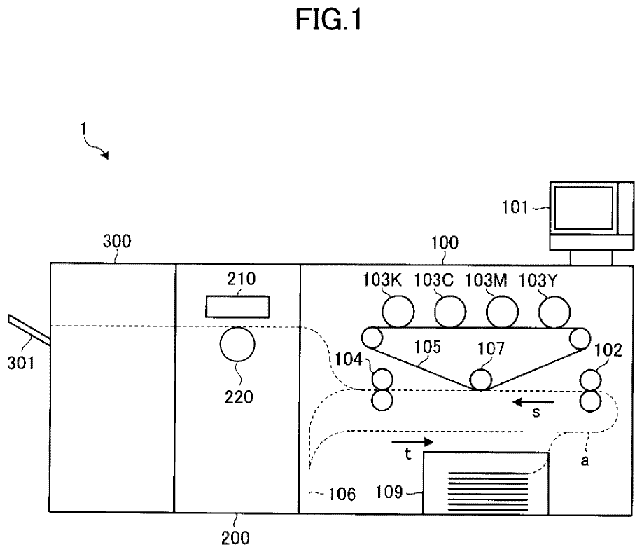

FIG. 1 is a diagram illustrating an example of an overall configuration of an image forming apparatus 1 according to an embodiment. FIG. 1 illustrates the interior of the image forming apparatus 1 in perspective.

The image forming apparatus 1 includes an image forming unit 100, an image inspection apparatus 200, and a stacker 300. The image forming unit 100 includes an operation panel 101, tandem electrophotographic image forming units 103Y, 103M, 103C, and 103K, a transfer belt 105, a secondary transfer roller 107, a sheet feeder 109, a pair of conveyance rollers 102, fixing rollers 104, and a reversing path 106.

The operation panel 101 is an operation display that performs various operation inputs to the image forming unit 100 and the image inspection apparatus 200, and displays various screens.

The image forming units 103Y, 103M, 103C, and 103K form toner images by image forming processes (a charging process, an exposure process, a developing process, a transfer process, and a cleaning process), and transfer the formed toner images to the transfer belt 105. In the image forming unit 100, a yellow toner image is formed on the image forming unit 103Y, a magenta toner image is formed on the image forming unit 103M, a cyan toner image is formed on the image forming unit 103C, and a black toner image is formed on the image forming unit 103K. However, the order of arrangement of the image forming units 103Y, 103M, 103C, and 103K is not limited to the above, and may be changed as appropriate. The image forming unit 100 may include an image forming unit that forms a toner image of a color other than yellow, magenta, cyan, and black. Colors other than yellow, magenta, cyan, and black are white and the like.

The transfer belt 105 conveys the full-color toner image transferred in a superimposed manner by the image forming units 103Y, 103M, 103C, and 103K to a secondary transfer position of the secondary transfer roller 107. First, a yellow toner image is transferred (primary transfer) onto the transfer belt 105, and subsequently, a magenta toner image, a cyan toner image, and a black toner image are sequentially transferred onto the transfer belt 105 in a superimposed manner. However, the order in which the toner images of respective colors are transferred onto the transfer belt 105 is not limited to the-above described order, and may be changed as needed. For simplification of illustration, the image forming units 103Y, 103M, 103C, and 103K are collectively referred to as an image forming unit 103 when the colors are not particularly distinguished from each other.

The sheet feeder 109 stores a plurality of recording media stacked together and feeds the recording media. Examples of the recording medium may include recording sheet (such as transfer sheet); however, the recording medium is not limited thereto. Any medium capable of forming (recording) an image may be used, such as coated paper, thick paper, OHP (Overhead Projector) sheets, plastic films, prepregs, and copper foils.

The pair of conveyance rollers 102 conveys the recording medium fed from the sheet feeder 109 in the direction of an arrow s on the conveying path a. The secondary transfer 107 roller collectively transfers (secondarily transfers) the full-color toner image conveyed by the transfer belt 105 onto the recording medium conveyed by the conveyance roller pair 102 at a secondary transfer position. The fixing rollers 104 fixes the full-color toner image to the recording medium by heating and pressing the recording medium to which the full-color toner image has been transferred.

In the case of single-sided printing, the image forming unit 100 sends the recording medium on which the full-color toner image is fixed to the image inspection apparatus 200. In the case of duplex printing, the image forming unit 100 sends the recording medium on which the full-color toner image is fixed to the reversing path 106.

The reversing path 106 reverses the front and back surfaces of the recording medium by switching back the fed recording medium, and conveys the recording medium in the direction of the arrow t. The recording medium conveyed through the reversing path 106 is conveyed again by a pair of conveyance rollers 102, and a full-color toner image is transferred onto a surface of the recording medium opposite to the previous surface by a secondary transfer roller 107, and is fixed by the fixing rollers 104. Thereafter, the sheet is sent to the image inspection apparatus 200 and the stacker 300.

The image inspection apparatus 200 is disposed downstream of the image forming unit 100 in the conveyance direction of the recording medium. The image inspection apparatus 200 includes an imager 210, a background unit 220, and the like, and inspects a defect of a printed image formed on a recording medium (inspection object) sent from the image forming unit 100. The image inspection apparatus 200 compares the inspection image with the non-defective image to detect a defect in the printed image. The non-defective image is an image serving as a sample of the printed image.

The image forming apparatus 1 processes image data as original data for forming a printed image to create a non-defective image. For example, information on the printing characteristics of the image forming unit 100 is acquired in advance by an experiment or simulation, and the image data is processed by converting the data image using the printing characteristic information. The produced non-defective image is a non-defective image produced by digital processing, and therefore can be referred to as a digital non-defective image or a digital master image.

In addition to the method of processing the image data, a non-defective image can also be created by reading an image serving as a sample by the imager 210. However, in this method, when the printed image is frequently changed, it is necessary to read the image as a sample by the imager 210 every time the printed image is changed, and thus the efficiency of the inspection may be reduced. In contrast, the method of processing image data is preferable because this method can skip a process of reading an image serving as a sample by the imager 210, whereby the efficiency of inspection is further increased.

The defect of the printed image includes a streak image, a spot image, dirt, a scratch, or the like which is visually recognized in the printed image. The “streak” refers to an image region extending in a linear shape having a different density from that of a peripheral region in a printed image. The spot image is a small dot-like image region having a different density from that of a peripheral region in the printed image. For example, the spot image is a small dot-like image attached to a white region of the inspection object. Such a streak, a spot image, and the like correspond to positive defects that should not be present in the printed image.

The defect of the printed image includes a void of the printed image, a printing error, or the like. The “void” refers to an image region where a toner image is not formed although the toner image is to be formed on the inspection object. The region where the toner image is to be formed corresponds to the non-defective feature that should be present, and the void corresponds to a negative defect that the non-defective feature in which should be present is not present in the inspection object.

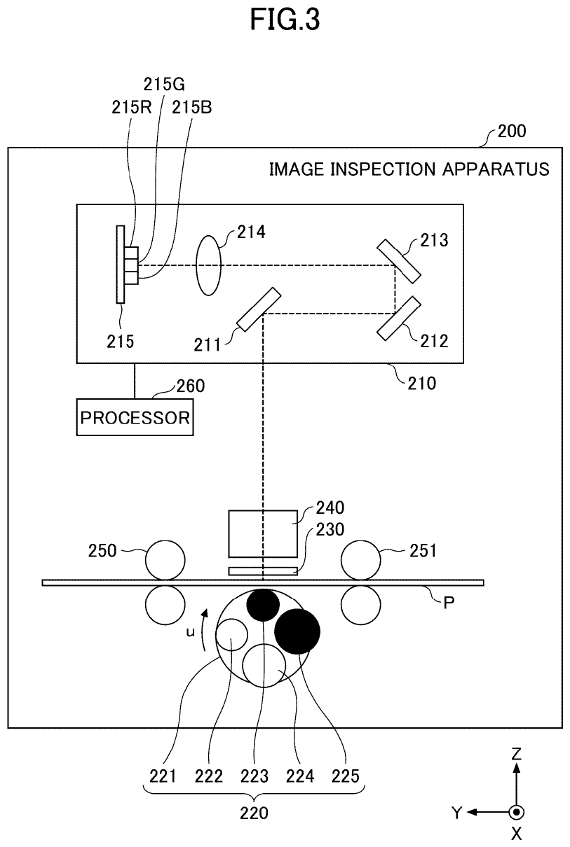

The inspection image is an image obtained by the imager 210 reading and imaging a printed image which is an inspection object. The configuration of the image inspection apparatus 200 will be described in detail later with reference to FIG. 3.

The image inspection apparatus 200 discharges the inspection object for which the inspection of the printed image has been completed to the stacker 300. The stacker 300 includes a tray 301. The stacker 300 stacks the inspection object discharged from the image inspection apparatus 200 on the tray 301.

### Hardware Configuration of Image Forming Apparatus According to Embodiment

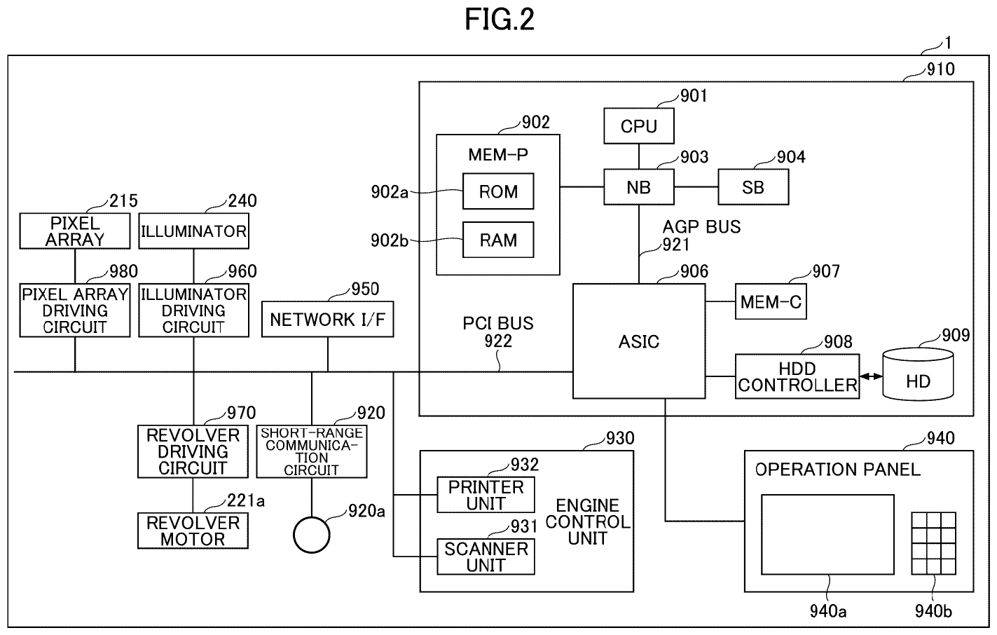

Next, a hardware configuration of the image forming apparatus 1 will be described with reference to FIG. 2. FIG. 2 is a block diagram illustrating an example of a hardware configuration of the image forming apparatus 1 according to the embodiment.

As illustrated in FIG. 2, the image forming apparatus 1 includes a controller 910, a short-range communication circuit 920, an engine control unit 930, an operation panel 940, and a network I/F 950.

The controller 910 includes a CPU 901 as a main part of the computer, a system memory (MEM-P) 902, a north bridge (NB) 903, a south bridge (SB) 904, an application specific integrated circuit (ASIC) 906, a local memory (MEM-C) 907 as a storage unit, an HDD controller 908, and an HD 909 as a storage unit. The NB 903 and the ASIC 906 are connected through an Accelerated Graphics Port (AGP) bus 921.

Among these, the CPU 901 is a control unit that performs overall control of the image forming apparatus 1. The NB 903 is a bridge for connecting the CPU 901, the MEM-P 902, the SB 904, and the AGP bus 921, and includes a memory controller that controls reading and writing to the MEM-P 902, a Peripheral Component Interconnect (PCI) master, and an AGP target.

The MEM-P 902 includes a ROM 902a as a memory that stores program and data for implementing various functions of the controller 910 and further includes a RAM 902b as a memory that loads the program and data, or as a drawing memory that stores drawing data for printing.

The program stored in the ROM 902a may be stored in any computer-readable storage medium, such as a compact disc-read only memory (CD-ROM), compact disc-recordable (CD-R), or digital versatile disc (DVD), in a file format installable or executable by the computer for distribution.

The SB 904 connects the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907.

The ASIC 906 is a PCI target and an AGP master, an arbiter (ARB) that forms the core of the ASIC 906, a memory controller that controls the MEM-C 907, and a plurality of DMACs (Direct Memory Access Controllers) that rotate image data by hardware logic and the like, and a PCI unit that transfers data between a scanner unit 931 and a printer unit 932 through the PCI bus 922.

A USB interface or an Institute of Electrical and Electronics Engineers 1394 (IEEE 1394) interface may be connected to the ASIC 906.

The MEM-C 907 is a local memory used as a buffer for image data to be copied or a code buffer. The HD 909 is a storage for storing image data, font data used during printing, and forms. The HDD controller 908 controls reading or writing of data to the HD 909 according to the control of the CPU 901.

The AGP bus 921 is a bus interface for a graphics accelerator card proposed for speeding up graphics processing. The AGP bus 921 directly accesses the MEM-P 902 with high throughput to accelerate the graphics accelerator card.

The short-range communication circuit 920 includes a short-range communication antenna 920a. The short-range communication circuit 920 is a communication circuit such as Near Field Communication (NFC) or Bluetooth (registered trademark).

Further, the engine control unit 930 includes the scanner unit 931 and the printer unit 932. The operation panel 940 also includes a display panel 940a and an operation panel 940b. The display panel 940a displays a current set value, a selection screen, or the like, and is provided with a touch panel or the like that receives input from an operator. Further, the operation panel 940b includes a numeric keypad that receives setting values of conditions related to image formation such as density setting conditions, a start key that receives a copy start instruction, and the like.

The controller 910 controls entire operation of the image forming apparatus 1. For example, the controller 910 controls rendering, communication, or inputs from the operation panel 940. The scanner unit 931 and the printer unit 932 each performs various image processing, such as error diffusion or gamma conversion.

The image forming apparatus 1 can sequentially switch and select the document box function, the copy function, the printer function, and the facsimile function by the application switching key of the operation panel 940.

The document box mode is selected when the document box function is selected, the copy mode is selected when the copy function is selected, the printer mode is selected when the printer function is selected, and the facsimile mode is selected when the facsimile function is selected.

The network I/F 950 is an interface for performing data communication using the network. The short-range communication circuit 920 and the network I/F 950 are electrically connected to the ASIC 906 through the PCI bus 922.

The image forming apparatus 1 further includes an illuminator driving circuit 960, a revolver driving circuit 970, and a pixel array driving circuit 980.

The illuminator driving circuit 960 is an electric circuit that is electrically connected to the illuminator 240 and drives the illuminator 240. The illuminator driving circuit 960 outputs a drive signal to the illuminator 240 in response to a control signal from a CPU 901 or the like, thereby controlling the intensity and timing of light emitted by the illuminator 240 onto the inspection object P.

The revolver driving circuit 970 is an electric circuit that is electrically connected to a revolver motor 221a attached to a revolver 221 and drives the revolver motor 221a. The revolver driving circuit 970 outputs a drive signal to the revolver motor 221a in response to a control signal from the CPU 901 or the like, thereby rotationally driving the revolver 221 to bring a predetermined roller of the white small-diameter roller 222, the white large-diameter roller 224, the black small-diameter roller 223, and the black large-diameter roller 225 into contact with the other surface of the inspection object P.

The pixel array driving circuit 980 is an electric circuit that is electrically connected to the pixel array 215 and drives the pixel array 215. An image signal from the pixel array 215 is input via the pixel array driving circuit 980, and can be subjected to predetermined processing or stored in a HD 909 or the like.

### <Configuration of Image Inspection Apparatus 200>

The configuration of the image inspection apparatus 200 will be described with reference to FIG. 3. FIG. 3 is a diagram illustrating an example of a configuration of the image inspection apparatus 200.

The image inspection apparatus 200 includes an imager 210 that captures an inspection image of an inspection object and a processor 260 that processes the inspection image captured by the imager 210. In the example illustrated in FIG. 3, the image inspection apparatus 200 includes a contact glass 230, an illuminator 240, and pairs of conveyance rollers 250 and 251.

The pairs of conveyance rollers 250 and 251 convey the inspection object P sent from the image forming unit 100 in the Y direction in FIG. 3. One of the pairs of conveyance rollers 250 and 251 may be a pair of driving rollers that are rotationally driven by a driving unit such as a motor, and the other may be a pair of driven rollers that rotate according to the conveyed inspection object P.

The contact glass 230 is made of transparent glass, and has a function of preventing fluttering or the like of the inspection object P at the time of reading (at the time of imaging) by the imager 210 by coming into contact with the conveyed inspection object P. As illustrated in FIG. 3, the inspection object P is conveyed in the Y direction between the contact glass 230 and the background unit 220.

The illuminator 240 is configured by an LED array or the like in which a plurality of LEDs (Light Emitting Diodes) are arranged in an axial direction (X direction in FIG. 3, hereinafter referred to as a width direction) of the pair of conveyance rollers 250 or the like, and illuminates the transported inspection object P with linear light.

However, the illuminator 240 is not limited to this configuration, and the LEDs of the respective colors of red, green, and blue may be simultaneously turned on, and the light of the respective colors may be mixed to emit light having a wide wavelength band close to white light. Further, the light source may be configured to have one element that emits light in a line shape long in the width direction, such as a fluorescent tube. The fluorescent tube can emit white light having uniform brightness in the width direction.

Further, a light guide member having a width direction as a longitudinal direction may be used, and white LEDs or red, green, and blue LEDs disposed at both ends of the light guide member may be turned on to emit linear light through the light guide member. The light guide member can emit light having uniform brightness in the width direction. Further, a light guide lens for efficiently guiding the light from the LED array to the region where the edge in the width direction of the conveyed inspection object P passes may be provided.

The imager 210 is provided on one surface side (positive Z direction side in FIG. 3) of the inspection object P which comes into contact with the contact glass 230, and is implemented by a contact image sensor (CIS) or the like. More specifically, the imager 210 includes mirrors 211 to 213, a lens 214, and a pixel array 215. The reflected light from the inspection object P of the light emitted from the illuminator 240 is reflected by the mirrors 211 to 213, respectively, as indicated by the broken line in FIG. 3, and is imaged on the light receiving surface of the pixel array 215 by the lens 214.

The pixel array 215 is an element in which photo diodes (PDs), which are photoelectric conversion elements that convert optical signals into electrical signals, are arranged in an array in the width direction. One photoelectric conversion element corresponds to one pixel and outputs an electric signal corresponding to the amount of received light. The pixel array 215 outputs an electric signal (image signal) of pixels for one line in the width direction. At this time, the pixel array 215 receives reflected light from the inspection object P conveyed in the Y direction by the pairs of conveyance rollers 250 and 251 at each predetermined timing, and outputs an image signal for one line. The image signals for one line output in this manner are connected in a direction orthogonal to the arrangement direction of the pixels in the pixel array 215, and thus two dimensional image data is acquired.

The pixel array 215 includes a pixel array 215R that receives red light, a pixel array 215G that receives green light, and a pixel array 215B that receives blue light, and each of the pixel arrays is arranged in a state where the width direction and the arrangement direction of the pixels are substantially parallel to each other.

The pixel array 215R that receives red light includes a red color filter in front of the light receiving surface, and receives red light that has passed through the color filter. The red color filter transmits light in a red wavelength band and absorbs or reflects light in other wavelength bands. Similarly, the pixel array 215G includes a green color filter and receives light in a green waveband, and the pixel array 215B includes a blue color filter and receives light in a blue waveband.

A charge coupled device (CCD), a complementary metal-oxide-semiconductor (CMOS), or the like may be used for the pixel array. Alternatively, the pixel array 215 may be formed using a CCD or CMOS area sensor having a two dimensional pixel array. Further, in order to increase the light collection efficiency of the pixel array 215, a rod lens array or the like for guiding the light reflected by the inspection object P to the pixel array 215 may be provided.

The imager 210 receives reflected light from the inspection object P and outputs an image signal including an inspection image formed on the inspection object P.

The background unit 220 includes a background member that comes into contact with the other surface side (the negative Z direction side in FIG. 3) of the inspection object P and serves as a background of the inspection object P when the edge of the inspection object P is read by the imager 210. The “other surface” is a surface on the opposite side to the surface of the inspection object P on the side on which the imager 210 is disposed.

The background unit 220 includes a revolver 221, a white small-diameter roller 222, a black small-diameter roller 223, a white large-diameter roller 224, and a black large-diameter roller 225. The white small-diameter roller 222, the white large-diameter roller 224, the black small-diameter roller 223, and the black large-diameter roller 225 are mounted on the revolver 221 so as to be arranged around the cylindrical axis of the cylindrical member included in the revolver 221.

A plurality of circular through holes penetrating in the cylindrical axis direction are formed in the cylindrical member included in the revolver 221. The through holes are formed so as to be arranged around the cylindrical axis of the revolver 221. The rollers are inserted into the through holes, so that the rollers can be mounted on the revolver 221.

The circular through hole does not necessarily have a circular cross-sectional shape, and may have a cross-sectional shape that is a portion of a circle. In addition, when a prismatic member or the like is mounted instead of the roller, a rectangular through hole may be formed.

The revolver 221 is rotatable about its cylindrical axis (in the direction of arrow u in FIG. 3). As an example, the motor attached to the revolver 221 is rotationally driven by a control signal, whereby the revolver 221 is rotated in the direction of the arrow u, and a predetermined roller of the plurality of rollers mounted on the revolver 221 can be brought into contact with the other surface of the inspection object P. However, an embodiment of the present disclosure is not limited to the rotation of the revolver 221 in response to the control signal, and an operator or the like of the image forming apparatus 1 may manually rotate the revolver 221 to bring a predetermined roller of the plurality of mounted rollers into contact with the other surface of the inspection object P.

In this manner, the white small-diameter roller 222, the white large-diameter roller 224, the black small-diameter roller 223, and the black large-diameter roller 225 are provided so as to be able to come in contact with the other surface of the inspection object P by the rotation of the revolver 221.

The white small-diameter roller 222 and the black small-diameter roller 223 have the same roller diameter, but have different roller colors. As an example, when a base color of the inspection object P is white, the contrast of the color between the inspection object P and the black small-diameter roller 223 as the background member is increased by bringing the black small-diameter roller 223 into contact with the other surface of the inspection object P, and thus the edge position of the inspection object P is more easily detected. Although the white small-diameter roller 222 and the black small-diameter roller 223 have been described above as examples, the same applies to the white large-diameter roller 224 and the black large-diameter roller 225. Further, although the white and black rollers are used as an example, the embodiment of the present disclosure is not limited thereto, and rollers of other colors may be used according to the color of the inspection object P.

The black small-diameter roller 223 and the black large-diameter roller 225 have the same color but different diameters. Therefore, when the black large-diameter roller 225 is brought into contact with the other surface of the inspection object P, the black large-diameter roller 225 pushes the inspection object P in the positive Z direction in FIG. 3, and thus the height in the direction (Z direction in FIG. 3) intersecting the surface of the inspection object P can be made different from that when the black small-diameter roller 223 is brought into contact with the other surface of the inspection object P. That is, when the black large-diameter roller 225 is brought into contact with the other surface of the inspection object P, the one surface of the inspection object P can be brought closer to the imager 210 than when the black small-diameter roller 223 is brought into contact with the other surface of the inspection object P.

The inspection object P may have a different thickness depending on the type, and the distance (height) from one surface of the inspection object P to the imager 210 is different between the thin inspection object P and the thick inspection object P. Due to such a difference in height, the image read by the imager 210 may include a defocus.

In particular, the imager 210 is configured to be thin, and thus the depth of field is shallow. Therefore, the read image is likely to be out of focus due to a slight difference in height from one surface of the inspection object P to the imager 210 caused by a difference in thickness of the inspection object P. When the defocused image is used, it is difficult to accurately detect the edge position of the inspection object P and the edge position of the image formed on the inspection object P.

In contrast, in the image inspection apparatus 200, for example, in the case of a thin inspection object P, the black large-diameter roller 225 is brought into contact with the other surface of the inspection object P, and thus it is possible to allow one surface of the inspection object P to approach the imager 210. Conversely, in the case of a thick inspection object P, the black small-diameter roller 223 is brought into contact with the other surface of the inspection object P, and thus it is possible to prevent one surface of the inspection object P from approaching the imager 210.

In this manner, the height from one surface of the inspection object P to the imager 210 can be made constant regardless of the thickness of the inspection object P, and the focus deviation in the read image can be prevented. Although the black small-diameter roller 223 and the black large-diameter roller 225 have been described above as examples, the same applies to the white small-diameter roller 222 and the white large-diameter roller 224.

In the example illustrated in FIG. 3, the roller is used as the background member, and the diameter of the roller is changed to change the “height”. However, the configuration of the background member is not limited to this example. For example, a prism may be used as the background member and the “height” can be made different by changing the height (thickness) dimension of the cross-sectional shape of the prism.

The processor 260 compares an inspection image obtained by capturing a printed image formed on the inspection object P sent from the image forming unit 100 with a non-defective image, and executes processing of detecting a defect of the printed image. The function of the processor 260 will be described in detail below.

### First Embodiment

### Functional Configuration Example of Processor 260

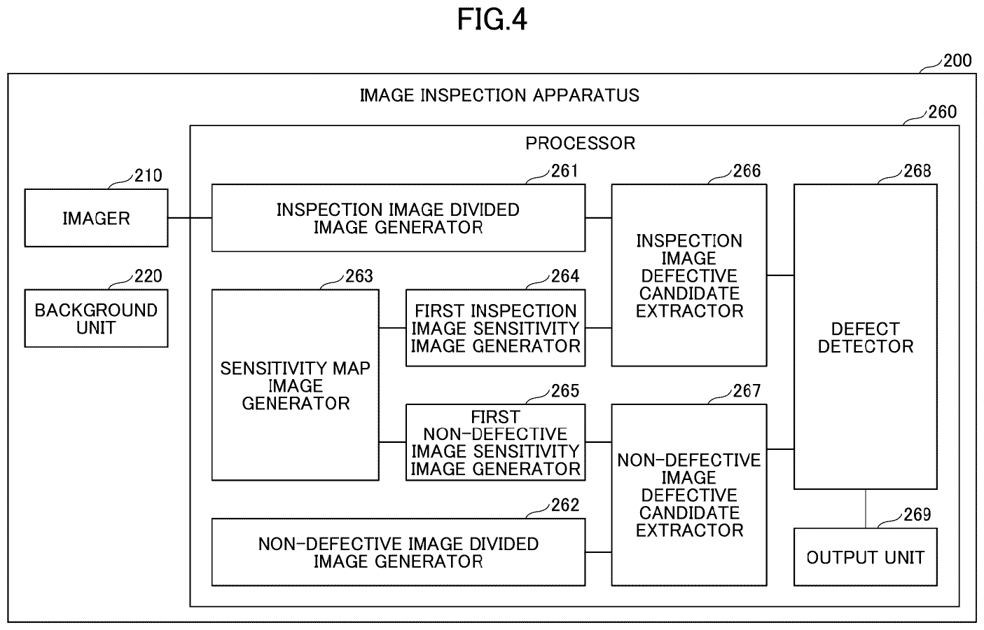

The functional configuration of the processor 260 included in the image inspection apparatus 200 according to a first embodiment will be described with reference to FIG. 4. FIG. 4 is a block diagram illustrating an example of a functional configuration of the processor 260.

The processor 260 includes an inspection image divided image generator 261 that generates an inspection image divided image using a first inspection image processed image. The first inspection image processed image is obtained by averaging luminance values of pixels in each of a plurality of processing regions into which an inspection image is divided under a predetermined first inspection image dividing condition. Also, the processor 260 includes a non-defective image divided image generator 262 that generates a non-defective image divided image using a first non-defective image processed image. The first non-defective image processed image is obtained by averaging luminance values of pixels in each of a plurality of processing regions into which a non-defective image to be compared with the inspection image is divided under a predetermined first non-defective image dividing condition. Also, the processor 260 includes a sensitivity map image generator 263 that generates a sensitivity map image which has the same size as the inspection image and the non-defective image and in which a detection threshold is set for each predetermined detection region. Also, the processor 260 includes a first inspection image sensitivity image generator 264 that divides the sensitivity map image into a plurality of regions under the first inspection image dividing condition, and generates a first inspection image sensitivity image obtained by processing a first inspection image threshold of each region according to the detection threshold. Also, the processor 260 includes a first non-defective image sensitivity image generator 265 that divides the sensitivity map image into a plurality of regions under the first non-defective image dividing condition, and generates a first non-defective image sensitivity image obtained by processing a first non-defective image threshold of each region according to the detection threshold. Also, the processor 260 includes an inspection image defective candidate extractor 266 that compares luminance values of pixels in an inspection image region of interest with luminance values of pixels in a processing region around the inspection image region of interest, from among a plurality of processing regions included in the inspection image divided image, and extracts an inspection image defective candidate region based on the first inspection image threshold. Also, the processor 260 includes a non-defective image defective candidate extractor 267 that compares luminance values of pixels in a non-defective image region of interest and luminance values of pixels in a processing region around the non-defective image region of interest among a plurality of processing regions included in the non-defective image divided image, and extracts a non-defective image defective candidate region based on the first non-defective image threshold. The processor 260 includes a defect detector 268 that compares the inspection image defective candidate region with the non-defective image defective candidate region to detect a defective region, and an output unit 269 that outputs a detection result of the defective region by the defect detector 268.

The image inspection apparatus 200 extracts a defective candidate using the inspection image divided image and the non-defective image divided image, which have been reduced in resolution by averaging the luminance values of the respective regions. The image inspection apparatus 200 can model a mechanism in which a human unconsciously recognizes a difference from a normal state, and extract a defective candidate of the inspection object P at high speed and with high sensitivity. The image inspection apparatus 200 can detect a positive defect and a negative defect at high speed and with high sensitivity by comparing a defective candidate in the inspection image with a defective candidate in the non-defective image.

In a typical image inspection apparatus, for example, when the same detection threshold is used as the defect detection threshold between regions where the pixel value changes significantly, such as in patterns or edges, and regions where the pixel value changes little, such as in the background, the defect detection accuracy may decrease. Specifically, when a low-sensitivity detection threshold is used to prevent false detections in regions with large pixel value sufficient detection accuracy may not be changes, achieved in regions with small pixel value changes. When a high-sensitivity detection threshold is used to achieve sufficient defect detection accuracy in regions with small pixel value changes, false detections may increase in regions with large pixel value changes.

In contrast, it is conceivable to prevent a decrease in defect detection accuracy by setting different detection thresholds between regions with large pixel value changes and regions with small pixel value changes. For example, by setting a low-sensitivity detection threshold in regions with large pixel value changes and a high-sensitivity detection threshold in regions with small pixel value changes, false detections may be prevented in regions with large pixel value changes, and sufficient defect detection accuracy may be achieved in regions with small pixel value changes.

However, when defects are detected using the low-resolution inspection image divided image and the low-resolution non-defective image divided image, the setting of detection thresholds for each region is also performed at a low resolution. As a result, the setting of detection thresholds for each region being at a low resolution may lead to a decrease in defect detection accuracy. For example, in regions with large pixel value changes, the effect of preventing false detections may be reduced, or in regions with small pixel value changes, sufficient defect detection accuracy may no longer be achieved.

The image inspection apparatus 200 according to the embodiment generates a sensitivity map image with a detection threshold set for each detection region by the sensitivity map image generator 263. In addition, the image inspection apparatus 200 reduces the resolution of the sensitivity map image under the first inspection image dividing condition by the first inspection image sensitivity image generator 264, as in the case of the inspection image. Further, the image inspection apparatus 200 reduces the resolution of the sensitivity map image under the first non-defective image dividing condition by the first non-defective image sensitivity image generator 265, as in the case of the non-defective image.

The image inspection apparatus 200 extracts the inspection image defective candidate region using a low-resolution inspection image sensitivity map image, and extracts the non-defective image defective candidate region using a low-resolution non-defective image sensitivity map image. The image inspection apparatus 200 detects a defective region using the inspection image defective candidate region and the non-defective image defective candidate region. Accordingly, in the image inspection apparatus 200, by aligning the resolutions of the inspection image divided image, the non-defective image divided image, and the sensitivity map image, a decrease in defect detection accuracy due to the low-resolution sensitivity map image can be prevented. For example, in the image inspection apparatus 200, in regions with large pixel value changes, false detections can be prevented, and in regions with small pixel value changes, sufficient defect detection accuracy can be achieved.

Accordingly, in the present embodiment, it is possible to provide the image inspection apparatus 200 and the image inspection method capable of inspecting the inspection object P at high speed and with high accuracy. Further, it is possible to provide the image forming apparatus 1 including the image inspection apparatus 200 capable of inspecting the inspection object P at high speed and with high accuracy. The functional configuration of the processor 260 will be described in detail below.

The functional configurations illustrated in FIG. 4 are functions or functional units that are implemented by operating any the of components illustrated in FIG. 2 in response to a command from the ROM 902a according to a program loaded from the RAM 902b onto the CPU 901. Although FIG. 4 illustrates the main configuration of the processor 260, the processor 260 may have a configuration other than these.

The predetermined first inspection image dividing condition in the inspection image divided image generator 261 is a dividing condition such as the number of divided regions, the size or shape of the divided region, or the like. The “each of the plurality of processing regions into which the inspection image is divided” refers to a region corresponding to each grid cell when the inspection image is divided into a plurality of regions in a grid-like matrix. The first inspection image processed image is a mosaic-like low resolution image including a plurality of regions in which the luminance values of all the pixels included in one region are replaced with the mean value of the luminance values of all the pixels included in the one region.

The predetermined first non-defective image dividing condition in the non-defective image divided image generator 262 is a dividing condition such as the number of divided regions, the size or shape of the divided region, or the like. The first non-defective image dividing condition may be the same as or different from the first inspection image dividing condition. The first non-defective image processed image is a mosaic-like low resolution image including a plurality of regions in which the luminance values of all the pixels included in one region are replaced with the mean value of the luminance values of all the pixels included in the one region.

In the example illustrated in FIG. 4, the non-defective image is created in advance and stored in the HD 909 or the like illustrated in FIG. 2. The non-defective image divided image generator 262 acquires a non-defective image with reference to the HD 909 or the like. The non-defective image is, for example, an image obtained by imaging an inspection object having no defect. Using an image obtained by imaging an inspection object having no defect as a non-defective image, the non-defective image can be easily acquired. However, the non-defective image is not limited to an image obtained by imaging an inspection object having no defect. For example, the non-defective image may be a digital master image generated based on image data serving as a source of the inspection image. Using the digital master image as a non-defective image, image characteristics such as color and resolution can be changed and adjusted, and the flexibility in selecting a non-defective image increases.

The detection threshold in the sensitivity map image generator 263 is set according to any one of, for example, a luminance value of the inspection image, a difference in luminance e between pixels of the inspection image region of interest and pixels of a processing region around the inspection image region of interest among the plurality of processing regions included in the inspection image divided image, or an input by a user of the image inspection apparatus 200. By setting the detection threshold in this manner, an appropriate detection threshold is set according to the change in the pixel values of the region. For example, a low-sensitivity detection threshold can be set in a region with the large pixel value changes, and a high-sensitivity detection threshold can be set in a region with the small pixel value changes.

The detection threshold in the first inspection image sensitivity image generator 264 is a detection threshold set by the sensitivity map image generator 263. The “processing according to the detection threshold” includes mean filter processing, maximum filter processing, minimum filter processing, median filter processing, or the like.

The mean filter processing is a process in which, for each of a plurality of regions obtained by dividing the sensitivity map image, a detection threshold averaged from a plurality of detection thresholds within the region is set as a unified detection threshold within that region. The maximum filter processing is a process in which, for each of a plurality of regions obtained by dividing the sensitivity map image, the detection threshold with the maximum value among a plurality of detection thresholds within the region is set as a unified detection threshold within that region. The minimum filter processing process in which, for each of a plurality of regions obtained by dividing the sensitivity map image, the detection threshold with the minimum value among a plurality of detection thresholds within the region is set as a unified detection threshold within that region. The median filter processing is a process in which, for each of a plurality of regions obtained by dividing the sensitivity map image, the detection threshold corresponding to the median value among a plurality of detection thresholds within the region is set as a unified detection threshold within that region.

The detection threshold in the first non-defective image sensitivity image generator 265 is a detection threshold set by the sensitivity map image generator 263, as in the case of the detection threshold in the first inspection image sensitivity image generator 264. The “processing according to the detection threshold” is mean filter processing, maximum filter processing, minimum filter processing, median filter processing, or the like.

The inspection image defective candidate extractor 266 calculates, for example, a difference in luminance value of pixels between the inspection image region of interest and a region around the inspection image region of interest, and extracts the inspection image region of interest as a defective candidate region when the difference value is equal to or larger than a predetermined threshold. The inspection image defective candidate extractor 266 performs the above-described processing on each of the plurality of regions in the inspection image divided image while changing the inspection image region of interest, thereby extracting the defective candidate region in the inspection image as the inspection image defective candidate region. The inspection image defective candidate extractor 266 sets the inspection image defective candidate region as an applicable region and sets a region other than the inspection image defective candidate region as a non-applicable region in the inspection image divided image, thereby visualizing and displaying the extracted inspection image defective candidate region.

The non-defective image defective candidate extractor 267 calculates, for example, a difference in luminance value of pixels between a non-defective image region of interest and a region around the non-defective image region of interest, and extracts the non-defective image region of interest as a defective candidate region when the difference value is equal to or larger than a predetermined threshold. The non-defective image defective candidate extractor 267 performs the above-described processing on each of the plurality of regions in the non-defective image divided image while changing the non-defective image region of interest, thereby extracting the defective candidate region in the non-defective image as a non-defective image defective candidate region. The non-defective image defective candidate extractor 267 sets the non-defective image defective candidate region as an applicable region and sets a region other than the non-defective image defective candidate region as a non-applicable region in the non-defective image divided image, thereby visualizing and displaying the extracted non-defective image defective candidate region.

The defect detector 268 removes (does not extract), for example, a defective candidate region common to both the inspection image defective candidate region and the non-defective image defective candidate region as a non-defective feature. The defect detector 268 can detect a region extracted only from the inspection image defective candidate region as a positive defective region which is present in the inspection image and is not present in the non-defective image. The defect detector 268 can detect a region extracted only from the non-defective image defective candidate region as a negative defective region which is present in the non-defective image and is not present in the inspection image.

The output unit 269 outputs the defect detection result in the printed image of the inspection object P as a detection result to a device or an apparatus other than the processor 260. The device or apparatus other than the processor 260 is an information processing apparatus, a display device, a storage device, a communication device, or the like other than the processor 260. The information processing apparatus is a personal computer (PC) or the like.

### Operation Example of Image Inspection Apparatus 200

The operation of the image inspection apparatus 200 will be described with reference to FIG. 5. FIG. 5 is a flowchart illustrating an example of an operation of the image inspection apparatus 200. FIG. 5 illustrates the operation of the image inspection apparatus 200 under the start condition that the inspection object P on which the printed image is formed is sent from the image forming unit 100 to the image inspection apparatus 200. However, the operation start condition of the image inspection apparatus 200 is not limited to the start condition that the inspection object P is sent from the image forming unit 100 to the image inspection apparatus 200. For example, the image inspection apparatus 200 may start the operation of FIG. 5 under a start condition that is an operation input for starting inspection performed by a user of the image inspection apparatus 200 or the image forming apparatus 1 using the operation panel 101.

First, in step S11, the image inspection apparatus 200 captures, by the imager 210, a printed image formed on an inspection object P as an inspection image.

Subsequently, in step S12, the image inspection apparatus 200 inputs an image signal including the inspection image captured by the imager 210 to the processor 260. The inspection image divided image generator 261 of the processor 260 divides the inspection image into a plurality of regions in a grid-like matrix according to the first inspection image dividing condition.

Subsequently, in step S13, the image inspection apparatus 200 generates, by the inspection image divided image generator 261, a first inspection image processed image obtained by averaging luminance values of pixels included in each of the plurality of divided regions.

Subsequently, in step S14, the image inspection apparatus 200 generates, by the inspection image divided image generator 261, an inspection image divided image using the first inspection image processed image. The inspection image divided image generator 261 passes the generated inspection image divided image to the inspection image defective candidate extractor 266.

Subsequently, in step S15, the image inspection apparatus 200 reads and acquires, by the non-defective image divided image generator 262, a non-defective image stored in the HD 909 or the like.

Subsequently, in step S16, the image inspection apparatus 200 divides, by the non-defective image divided image generator 262, the non-defective image into a plurality of regions in a grid-like matrix according to the first non-defective image dividing condition.

Subsequently, in step S17, the image inspection apparatus 200 generates, by the non-defective image divided image generator 262, a first non-defective image processed image obtained by averaging luminance values of pixels included in each of the plurality of divided regions.

Subsequently, in step S18, the image inspection apparatus 200 generates, by the non-defective image divided image generator 262, a non-defective image divided image using the first non-defective image processed image. The non-defective image divided image generator 262 passes the generated non-defective image divided image to the non-defective image defective candidate extractor 267.

Subsequently, in step S19, the image inspection apparatus 200 generates, by the sensitivity map image generator 263, a sensitivity map image.

Subsequently, in step S20, the image inspection apparatus 200 divides, by the first inspection image sensitivity image generator 264, the sensitivity map image into a plurality of regions under the first inspection image dividing condition and generates a first inspection image sensitivity image. The first inspection image sensitivity image generator 264 passes the first inspection image sensitivity image to the inspection image defective candidate extractor 266.

Subsequently, in step S21, the image inspection apparatus 200 divides, by the first non-defective image sensitivity image generator 265, the sensitivity map image into a plurality of regions under the first non-defective image dividing condition and generates a first non-defective image sensitivity image. The first non-defective sensitivity image generator 265 passes the first non-defective sensitivity image to the non-defective image defective candidate extractor 267.

Subsequently, in step S22, the image inspection apparatus 200 compares, by the inspection image defective candidate extractor 266, luminance values of pixels in an inspection image region of interest with luminance values of pixels in a processing region around the inspection image region of interest among the plurality of processing regions included in the inspection image divided image, and extracts an inspection image defective candidate region based on the first inspection image threshold. The inspection image defective candidate extractor 266 passes the extracted inspection image defective candidate region to the defect detector 268.

Subsequently, in step S23, the image inspection apparatus 200 compares, by the non-defective image defective candidate extractor 267, luminance values of pixels in a non-defective image region of interest with luminance values of pixels in a processing region around the non-defective image region of interest among a plurality of processing regions included in the non-defective image divided image, and extracts the non-defective image defective candidate region based on the first non-defective image threshold. The non-defective image defective candidate extractor 267 passes the extracted non-defective image defective candidate region to the defect detector 268.

Subsequently, in step S24, the image inspection apparatus 200 compares, by the defect detector 268, the inspection image defective candidate region with the non-defective image defective candidate region and detects a defective region. The defect detector 268 passes the detection result of the defective region to the output unit 269.

Subsequently, in S25, step the image inspection apparatus 200 outputs, by the output unit 269, the detection result of the defective region (defect detection result) to an apparatus or a device other than the processor 260.

The image inspection apparatus 200 can inspect defects in the inspection object P in this manner.

In FIG. 5, the operation with respect to the non-defective image from step S15 to step S18 may be performed before the operation with respect to the inspection image from step S11 to step S14, and the operation with respect to the non-defective image and the operation with respect to the inspection image may be performed in parallel.

The operation of step S19 in FIG. 5 may be performed at any timing from step S11 to step S18. The operation of step S21 may be performed prior to the operation of step S20, and the operation of step S21 and the operation of step S20 may be performed in parallel. The operation of step S23 may be performed prior to the operation of step S22, and the operation of step S23 and the operation of step S22 may be performed in parallel.

### <Processing Result by Processor 260>

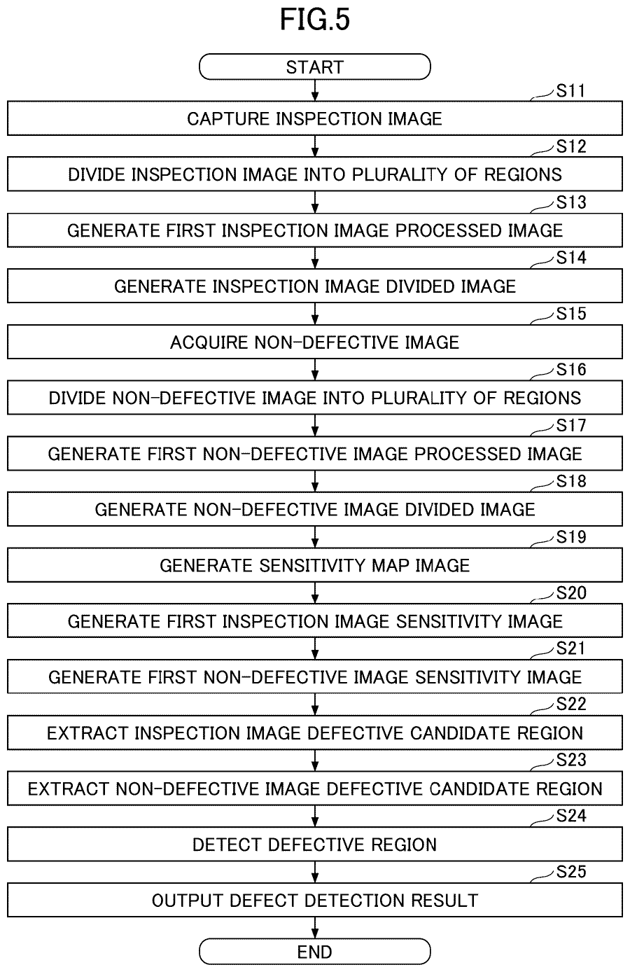

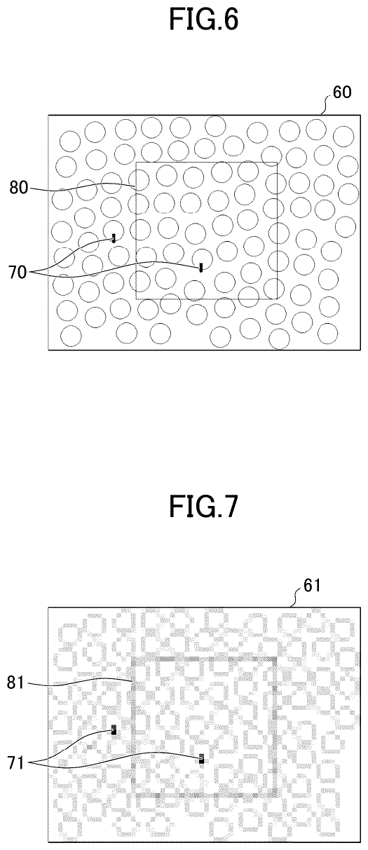

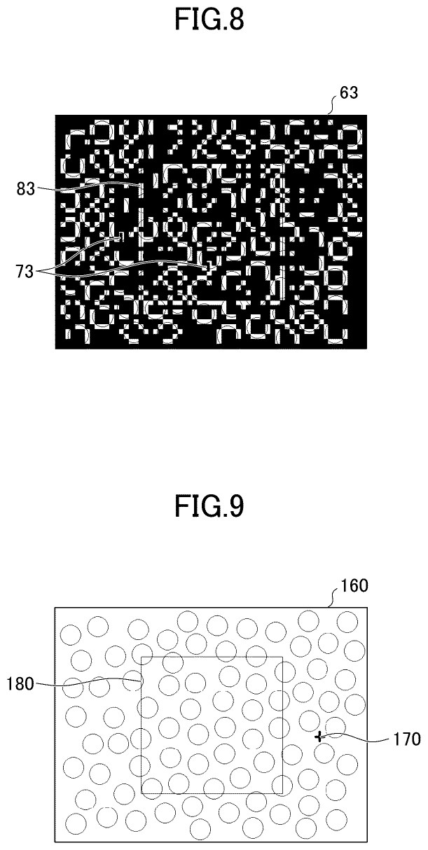

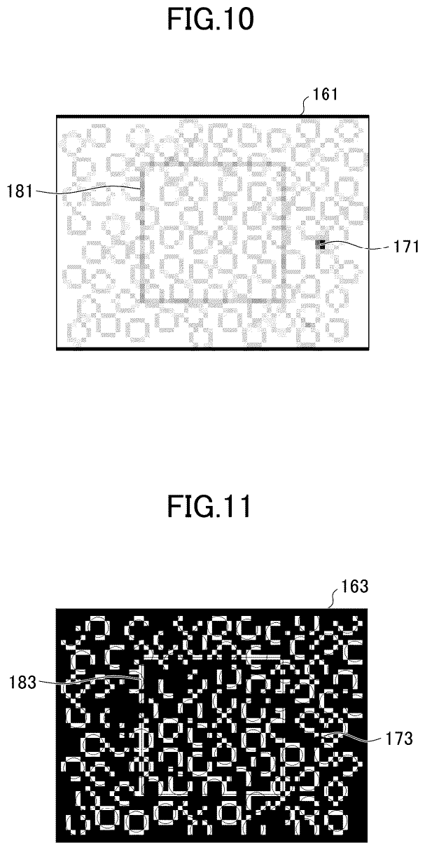

FIG. 6 is a diagram illustrating an example of an inspection image 60. FIG. 7 is a diagram illustrating an example of a first inspection image processed image 61. FIG. 8 is a diagram illustrating an example of an inspection image defective candidate region image 63 obtained from the first inspection image processed image 61 of FIG. 7. FIG. 9 is a diagram illustrating an example of a non-defective image 160. FIG. 10 is a diagram illustrating an example of a first non-defective image processed image 161. FIG. 11 is a diagram illustrating an example of a non-defective image defective candidate region image 163 obtained from the first non-defective image processed image 161 of FIG. 10.

The inspection image 60 illustrated in FIG. 6 includes defects 70 and a non-defective feature 80. The first inspection image processed image 61 illustrated in FIG. 7 is a mosaic-like image resulting from averaging luminance values of pixels in each of the plurality of processing regions into which the inspection image 60 is divided. The first inspection image processed image 61 is a mosaic-like image resulting from averaging luminance values of pixels in each of a plurality of processing regions into which the inspection image 60 divided. The first inspection image processed image 61 includes defective regions 71 corresponding to the defects 70 and a non-defective feature region 81 corresponding to the non-defective feature 80. The inspection image divided image is obtained using the first inspection image processed image 61.

In the inspection image defective candidate region image 63 illustrated in FIG. 8, a region other than the inspection image defective candidate region is displayed in black as a non-applicable region. The inspection image defective candidate region image 63 illustrated in FIG. 8 includes inspection image defective candidate regions 73 corresponding to the defects 70 and an inspection image defective candidate region 83 corresponding to the non-defective feature 80.

The non-defective image 160 illustrated in FIG. 9 includes a defect 170 and a non-defective feature 180. The defect 170 is not included in the inspection image 60, and corresponds to a negative defect in which the inspection object P does not have a non-defective feature that should be present.

The first non-defective image processed image 161 illustrated in FIG. 10 is a mosaic-like image resulting from averaging luminance values of pixels in each of the plurality of processing regions into which the non-defective image 160 is divided. The first non-defective image processed image 161 includes a defective region 171 corresponding to the defect 170 and a non-defective feature region 181 corresponding to the non-defective feature 180. The non-defective image divided image is obtained using the first non-defective image processed image 161.

In the non-defective image defective candidate region image 163 illustrated in FIG. 11, a region other than the non-defective image defective candidate region is displayed in black as a non-applicable region. The non-defective image defective candidate region image 163 illustrated in FIG. 11 includes a non-defective image defective candidate region 173 corresponding to the defect 170 and a non-defective image defective candidate region 183 corresponding to the non-defective feature 180.

The defect detector 268 compares, for example, the inspection image defective candidate region image 63 of FIG. 8 with the non-defective image defective candidate region image 163 of FIG. 11, and removes (does not extract) a defective candidate region common to both images as a non-defective feature. The defect detector 268 detects the region extracted only from the inspection image defective candidate region image 63 as a positive defective region which is present in the inspection image 60 and is not present in the non-defective image 160. The defect detector 268 detects a region extracted only from the non-defective image defective candidate region image 163 as a negative defective region which is present in the non-defective image 160 and is not present in the inspection image 60. In this manner, the image inspection apparatus 200 can detect both the positive defect and negative defect.

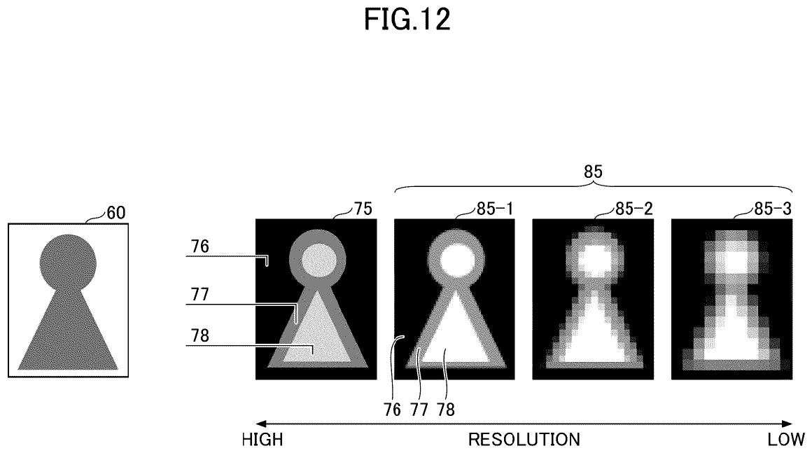

FIG. 12 is a diagram illustrating a sensitivity map image 75 and a first inspection image sensitivity image 85. FIG. 12 illustrates the inspection image 60, the sensitivity map image 75, and the first inspection image sensitivity image 85.

The sensitivity map image 75 is an image having the same size as the inspection image 60, and is an image in which a detection threshold is set for each predetermined detection region. The first inspection image sensitivity image 85 is an image obtained by dividing the sensitivity map image 75 into a plurality of regions under the first inspection image dividing condition and processing the first inspection image threshold of each region according to the detection threshold.

A first inspection image sensitivity image 85-1, a first inspection image sensitivity image 85-2, and a first inspection image sensitivity image 85-3 are first inspection image sensitivity images having different resolutions. The resolution of the first inspection image sensitivity image 85-1 is the highest, and the resolution decreases in the order of the first inspection image sensitivity image 85-2 and the first inspection image sensitivity image 85-3. Note that the first inspection image sensitivity image 85 is a generic term in a case where the first inspection image sensitivity image 85-1, the first inspection image sensitivity image 85-2, and the first inspection image sensitivity image 85-3 are not particularly distinguished.

The sensitivity map image 75 and the first inspection image sensitivity image 85 include a dead zone region 76, a low sensitivity region 77, and a high sensitivity region 78, respectively. The dead zone region 76 is a region which is not a target of defect detection, and is a region in which a detection threshold is not set. The low sensitivity region 77 and the high sensitivity region 78 are regions which are a target for defect detection. The low sensitivity region 77 is a region with large pixel value changes, including a picture pattern, an edge, and the like, and is a region in which a detection threshold is set to be high. The high-sensitivity region 78 is a region with small pixel value changes, including a background or the like, and is a region in which a detection threshold is set to be low.

The first inspection image sensitivity image 85 is obtained by dividing the inspection image 60 under the first inspection image dividing condition, and dividing the sensitivity map image 75 under the first inspection image dividing condition according to image divided image with reduced the inspection resolution, thereby reducing the resolution. Accordingly, the resolution of the first inspection image sensitivity image 85 can be matched with the resolution of the inspection image divided image. By matching the resolution of the first inspection image image 85 with the resolution of the sensitivity inspection image divided image, a decrease in defect detection accuracy due to the sensitivity map image 75 having a reduced resolution is prevented. Although FIG. 12 illustrates an example corresponding to the inspection image, the same processing can be applied to a non-defective image.

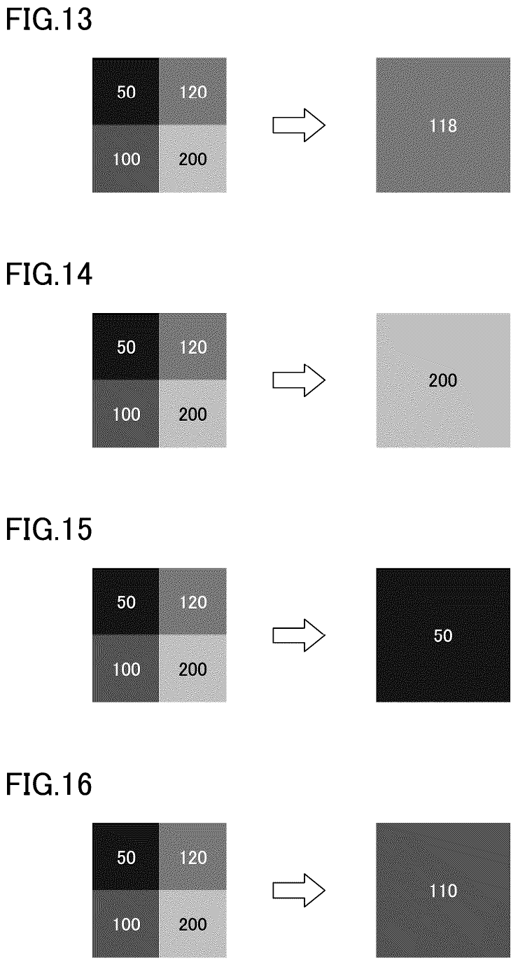

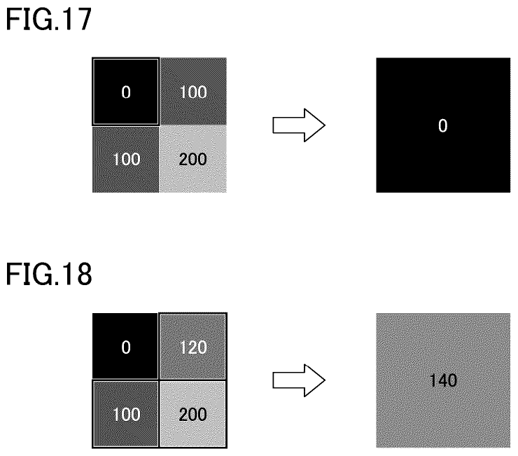

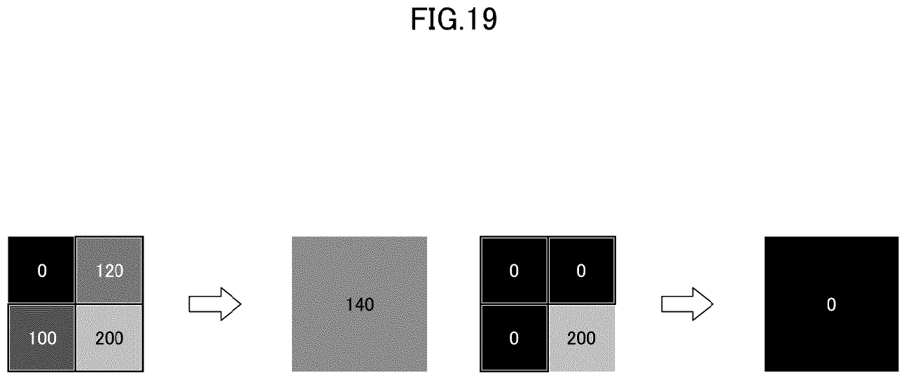

FIGS. 13 to 19 are diagrams illustrating the processing of the first inspection image sensitivity image 85. FIG. 13 is a diagram illustrating the mean filter processing of the first inspection image sensitivity image 85. FIG. 14 is a diagram illustrating the maximum filter processing of the first inspection image 85. FIG. 15 is a diagram image sensitivity illustrating the minimum filter processing of the first inspection image sensitivity image 85. FIG. 16 is a diagram illustrating the median filter processing of the first inspection image sensitivity image 85. FIG. 17 is a diagram illustrating a first example of the dead zone processing of the first inspection image sensitivity image 85. FIG. 18 is a diagram illustrating a second example of the dead zone processing of the first inspection image sensitivity image 85. FIG. 19 is a diagram illustrating a third example of the dead zone processing of the first inspection image sensitivity image 85.

FIGS. 13 to 16 each illustrate a state in which the luminance values of four pixels among the pixels constituting the first inspection image sensitivity image 85 are processed. The luminance values of the four pixels are 50, 120, 100 and 200. In the mean filter processing illustrated in FIG. 13, the luminance values of the four pixels are averaged to calculate the luminance value “118”, and the luminance value of each of the four pixels is replaced with 118. In the maximum filter processing illustrated in FIG. 14, the luminance value “200” that is the maximum value among the luminance values of the four pixels is selected, and the luminance value of each of the four pixels is replaced with 200. In the minimum filter processing illustrated in FIG. 15, the luminance value “50” that is the minimum value among the luminance values of the four pixels is selected, and the luminance value of each of the four pixels is replaced with 50. In the median filter processing illustrated in FIG. 16, the luminance value “110” which is the median value of the luminance values of the four pixels is selected, and the luminance value of each of the four pixels is replaced with 110.

FIGS. 17 to 19 each illustrate a state in which the luminance values of four pixels among the pixels constituting the first inspection image sensitivity image 85 are processed. In the first example illustrated in FIG. 17, the luminance values of the four pixels are 0, 100, 100, and 200. A pixel with a luminance value of 0 corresponds to the dead zone. In the first example, the luminance values of four pixels are replaced with 0, and the pixels are set in the dead zone. In the second example illustrated in FIG. 18, the luminance values of the four pixels are 0, 120, 100, and 200. In the second example, the luminance values of the pixels other than the dead zone are averaged, and thus the luminance value “140” is calculated, and the luminance values of the four pixels are replaced with 140.

In the third example illustrated in FIG. 19, the luminance values of four pixels are 0, 120, 100, and 200, and 0, 0, 0, and 200. When the luminance values of the four pixels are 0, 0, 0, and 200, the dead zone is a majority. When the luminance values of the four pixels are 0, 120, 100, and 200, the dead zone is other than the majority. When the dead zone is a majority, all the luminance values of the four pixels are set to 0, and the pixels are set to the dead zone. When the dead zone is other than the majority, the luminance values of the pixels which are not in the dead zone are averaged, and all the luminance values of the four pixels are replaced with the luminance value “140” which is the mean value.

Although the mean filter processing is exemplified in FIGS. 13 to 19, the maximum filter processing, the minimum filter processing, the median filter processing, or the like may be performed instead of the mean filter processing.

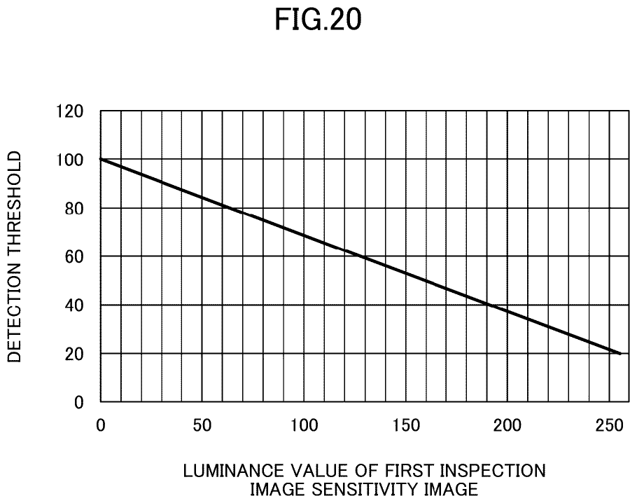

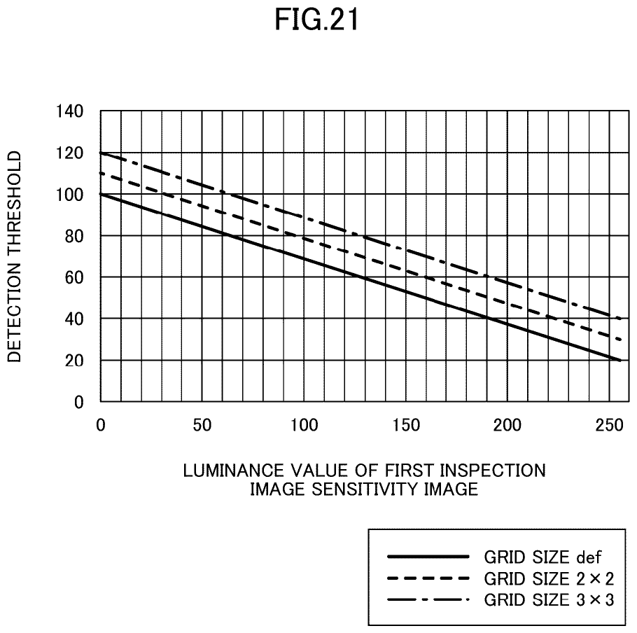

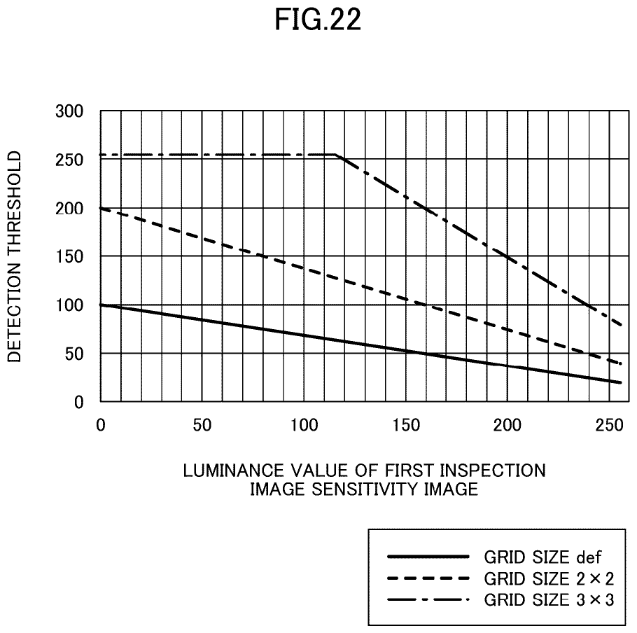

FIG. 20 is a diagram illustrating a first example of the relationship between the luminance value of the first inspection image sensitivity image 85 and the detection threshold. FIG. 21 is a diagram illustrating a second example of the relationship between the luminance value of the first inspection image sensitivity image 85 and the detection threshold. FIG. 22 is a diagram illustrating a third example of the relationship between the luminance value of the first inspection image sensitivity image 85 and the detection threshold.

In the first example illustrated in FIG. 20, the luminance value of the first inspection image sensitivity image 85 and the detection threshold have a proportional relationship, and the range of numerical values is limited. However, the luminance value of the first inspection image sensitivity image 85 and the detection threshold may have a relationship other than a proportional relationship. The relationship other than the proportional relationship is a relationship represented by a logarithm, an exponent, a polynomial, or the like.

In the second example illustrated in FIG. 21 and the third example illustrated in FIG. 22, the relationship between the luminance value of the first inspection image sensitivity image 85 and the detection threshold is changed depending on the resolution (that is, the grid size formed by the pixels). In the second example illustrated in FIG. 21, the luminance value of the first inspection image sensitivity image 85 and the detection threshold have a proportional relationship. The proportionality coefficient is different for each grid size. In the third example illustrated in FIG. 22, in the grid size def and the grid size 2×2, the luminance value of the first inspection image sensitivity image 85 and the detection threshold have a proportional relationship, and the slopes are different. In the case of the grid size of 3×3, the detection threshold is constant when the luminance value of the first inspection image sensitivity image 85 is less than 118, and the luminance value of the first inspection image sensitivity image 85 and the detection threshold are in a proportional relationship when the luminance value of the first inspection image sensitivity image 85 is 119 or more.

As illustrated in FIGS. 20 to 22, the relationship between the luminance value of the first inspection image sensitivity image 85 and the detection threshold can be determined by a mathematical expression. That is, the first inspection image sensitivity image generator 264 illustrated in FIG. 4 can calculate the first inspection image threshold by a mathematical expression based on the detection threshold. The first inspection image sensitivity image generator 264 calculates the first inspection image threshold using the mathematical expression, and thus it is possible to simplify the processing compared to a case where a table in which the detection threshold and the first inspection image threshold are associated with each other is used. In addition, since the storage capacity for the table is not required, the storage capacity of the image inspection apparatus 200 can be reduced.

Although the processing by the first inspection image sensitivity image generator 264 is illustrated in FIGS. 20 to 22, the first non-defective image sensitivity image generator 265 illustrated in FIG. 4 can also execute the same processing as the processing by the first inspection image sensitivity image generator 264 illustrated in FIGS. 20 to 22. That is, the first non-defective image sensitivity image generator 265 can calculate the first non-defective image threshold by a mathematical expression based on the detection threshold. The first non-defective image sensitivity image generator 265 calculates the first inspection image threshold using a mathematical expression, and thus simplify the processing compared to a case where a table or the like in which the detection threshold and the first non-defective image threshold are associated with each other is used. Furthermore, since there is no need to store such a table, the storage capacity required for the image inspection apparatus 200 can be reduced.

### Second Embodiment

Next, an image forming apparatus according to a second embodiment will be described. The same names and reference numerals as those in the above-described embodiment denote the same or similar members or configurations, and a detailed description thereof will be appropriately omitted. The same is applied to the embodiments described below.

### Functional Configuration of Processor Included in Image Inspection Apparatus According to Second Embodiment

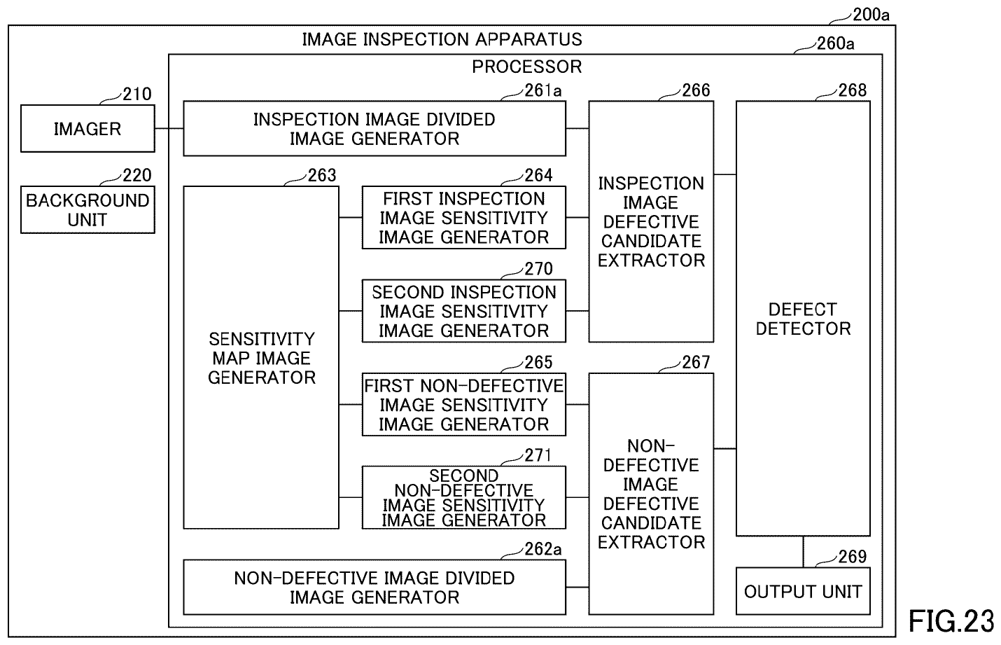

FIG. 23 is a block diagram illustrating an example of a functional configuration of a processor 260a included in an image inspection apparatus 200a according to a second embodiment. The processor 260a differs from the processor 260 in the first embodiment in that the processor 260a includes an inspection image divided image generator 261a, a non-defective image divided image generator 262a, a second inspection image sensitivity image generator 270, and a second non-defective image sensitivity image generator 271.

The inspection image divided image generator 261a generates an inspection image divided image using at least one of a first inspection image processed image or a second inspection image processed image. The first inspection image processed image is obtained by averaging luminance values of pixels in each of a plurality of processing regions into which an inspection image is divided under a predetermined first inspection image dividing condition. The second inspection image processed image is obtained by averaging luminance values of pixels in each of a plurality of processing regions into which the inspection image is divided under a second inspection image dividing condition in which at least one of a phase, a direction, and a size differs from that of the first inspection image dividing condition.

For example, the inspection image divided image generator 261a generates the inspection image divided image by selecting one of the first inspection image processed image and the second inspection image processed image. From the viewpoint that the first inspection image processed image becomes the inspection image divided image or the second inspection image processed image becomes the inspection image divided image, the inspection image divided image can be said to be a generic term of the first inspection image processed image and the second inspection image processed image.

In the inspection image defective candidate region and the non-defective image defective candidate region used for comparison by the defect detector 268, it is preferable that a phase, direction, or size of the region (grid) applied when the inspection image divided image and the non-defective image divided image as the source are generated are the same.

In the inspection image divided image generator 261a, the “phase of a region” refers to the position of a grid that divides an image such as an inspection image into a plurality of regions. The “direction of the region” refers to the direction in which the phase of the region is shifted. The “direction of the region” is basically either vertical (column direction of the grid) or horizontal (row direction of the grid), but may also include an oblique direction defined by an angle of rotation about the center point of the grid. The “size of the region” refers to the area of the region. The area of the region is, for example, an area expressed by the number of pixels, such as 10×10 pixels. In each of the plurality of processing regions into which the inspection image is divided under the second inspection image dividing condition, the luminance values of all the pixels included in a single processing region are replaced with the mean value of the luminance values of all the pixels in that region. The second inspection image processing image is a mosaic-like low resolution image composed of such a plurality of regions.

The non-defective image divided image generator 262a generates a non-defective image divided image using at least one of a first non-defective image processed image or a second non-defective image processed image. The first non-defective image processed image is obtained by averaging luminance values of pixels in each of a plurality of processing regions into which a non-defective image to be compared with the inspection image is divided under a predetermined first non-defective image dividing condition. The second non-defective image processed image is obtained by averaging luminance values of pixels in each of a plurality of processing regions into which the non-defective image is divided under a second non-defective image dividing condition in which at least one of a phase, a direction, or a size differs from that of the first non-defective image dividing condition.

For example, the non-defective image divided image generator 262a generates the non-defective image divided image by selecting one of the first non-defective image processed image and the second non-defective image divided image. From the viewpoint that the first non-defective image processed image becomes the non-defective image divided image, or the second non-defective image divided image becomes the non-defective image divided image, the non-defective image divided image can be said to be a generic term of the first non-defective image processed image and the second non-defective image divided image.

In the non-defective image divided image generator 262a, in each of the plurality of processing regions into which the non-defective image is divided under the second non-defective image dividing condition, the luminance values of all the pixels included in one processing region are replaced with the mean value of the luminance values of all the pixels included in one processing region. The second non-defective image divided image is a mosaic-like low resolution image including such a plurality of regions.

The image inspection apparatus 200a generates an inspection image divided image using at least one of the first inspection image processed image and the second inspection image processed image. The image inspection apparatus 200a generates the non-defective image divided image using at least one of the first non-defective image processed image and the second non-defective image divided image. The image inspection apparatus 200a detects a defective region of the inspection image using the inspection image divided image and the non-defective image divided image generated as described above, and thus can detect the defective region at high speed and with high sensitivity using a mechanism in which a human recognizes a difference from a normal state without conscious awareness.

The first inspection image sensitivity image generator 264 may calculate the first inspection image threshold by a mathematical expression based on the detection threshold, and the first non-defective image sensitivity image generator 265 may calculate the first non-defective image threshold by a mathematical expression based on the detection threshold. The second inspection image sensitivity image generator 270 may calculate the second inspection image threshold by a mathematical expression based on the detection threshold, and the second non-defective image sensitivity image generator 271 may calculate the second non-defective image threshold by a mathematical expression based on the detection threshold.

By calculating the first inspection image threshold, the first non-defective image threshold, the second inspection image threshold, and the second non-defective image threshold using the mathematical expressions, the processing can be simplified compared to a case where a table in which the first inspection image threshold, the first non-defective image threshold, the second inspection image threshold, and the second non-defective image threshold are associated with the detection threshold is used. Furthermore, since there is no need to store such a table, the storage capacity required for the image inspection apparatus 200 can be reduced.

### Operation Example of Image Inspection Apparatus 200a

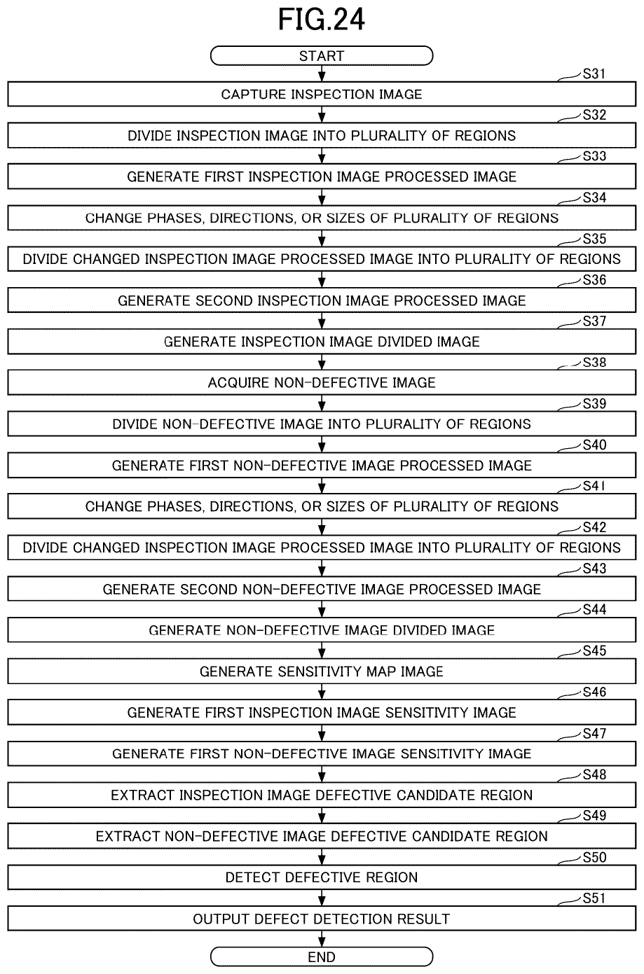

The operation of the image inspection apparatus 200a will be described with reference to FIG. 24. FIG. 24 is a flowchart illustrating an example of an operation of the image inspection apparatus 200a. FIG. 24 illustrates the operation of the image inspection apparatus 200a under the start condition that the inspection object P on which the printed image is formed is sent from the image forming unit 100 to the image inspection apparatus 200a. However, the operation start condition of the image inspection apparatus 200a is not limited to the start condition that the inspection object P is sent from the image forming unit 100 to the image inspection apparatus 200a. For example, the image inspection apparatus 200a may start the operation of FIG. 24 under a start condition of an operation input for starting inspection performed by a user of the image inspection apparatus 200a or the image forming apparatus 1 using the operation panel 101. The operation of the image inspection apparatus 200a will be described focusing on the difference from the operation of the image inspection apparatus 200 illustrated in FIG. 5.

The processing from step S31 to step S33 is the same as the processing from step S11 to step S13 in FIG. 5.

In step S34, the image inspection apparatus 200a changes, by the inspection image divided image generator 261a, at least one of a phase, direction, or size of each of the plurality of divided processing regions with respect to the first inspection image processed image.

Subsequently, in step S35, the image inspection apparatus 200a divides, by the inspection image divided image generator 261a, the first inspection image processed image into a plurality of processing regions, each of which is obtained by changing at least one of a phase, direction, or size with respect to the first inspection image processed image.

Subsequently, in step S36, the image inspection apparatus 200a generates, by the inspection image divided image generator 261a, a second inspection image processed image by averaging luminance values of pixels included in each of the plurality of divided processing regions.

Subsequently, in step S37, the image inspection apparatus 200a generates, by the inspection image divided image generator 261a, an inspection image divided image using at least one of the first inspection image processed image or the second inspection image processed image.

The processing from step S38 to step S40 is the same as the processing from step S15 to step S17 in FIG. 5.

In step S41, the image inspection apparatus 200a changes, by the non-defective image divided image generator 262a, at least one of a phase, direction, or size of each of the plurality of divided processing regions with respect to the first non-defective image processed image.

Subsequently, in step S42, the image inspection apparatus 200a divides, by the non-defective image divided image generator 262a, the first non-defective image processed image into a plurality of processing regions each of which is obtained by changing at least one of a phase, direction, or size with respect to the first non-defective image processed image.

Subsequently, in step S43, the image inspection apparatus 200a generates, by the non-defective image divided image generator 262a, a second non-defective image divided image by averaging luminance values of pixels included in each of the plurality of divided processing regions.

Subsequently, in step S44, the image inspection apparatus 200a generates, by the non-defective image divided image generator 262a, a non-defective image divided image using at least one of the first non-defective image processed image and the second non-defective image divided image.

The processing from step S45 to step S51 is the same as the processing from step S19 to step S25.

The image inspection apparatus 200a can inspect defects in the inspection object P in this manner.

In FIG. 24, the operations with respect to the non-defective image from step S38 to step S44 may be performed before the operations with respect to the inspection image from step S31 to step S37, and the operations with respect to the non-defective image and the operations with respect to the inspection image may be performed in parallel.

The operation of step S45 in FIG. 24 may be performed at any timing from step S31 to step S44. The operation of step S47 may be performed prior to the operation of step S46, and the operation of step S47 and the operation of step S46 may be performed in parallel. The operation of step S49 may be performed prior to the operation of step S48, and the operation of step S49 and the operation of step S48 may be performed in parallel.

<Processing Result by Processor 260a>

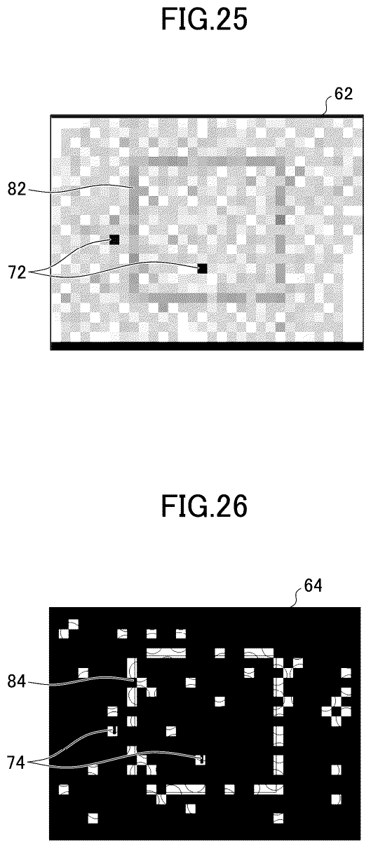

FIG. 25 is a diagram illustrating an example of a second inspection image processed image 62. FIG. 26 is a diagram illustrating an example of an inspection image defective candidate region image 64 obtained from the second inspection image processed image 62 in FIG. 25.

The second inspection image processed image 62 illustrated in FIG. 25 differs from the first inspection image processed image 61 illustrated in FIG. 7 in a phase and size of each of a plurality of regions into which the inspection image 60 is divided by a grid. Thus, the second inspection image processed image 62 is a coarse mosaic-like image compared to the first inspection image processed image 61. The second inspection image processed image 62 includes defective regions 72 corresponding to the defects 70 illustrated in FIG. 6 and a non-defective feature region 82 corresponding to the non-defective feature 80 illustrated in FIG. 6.

The inspection image defective candidate region image 64 illustrated in FIG. 26 includes inspection image defective candidate regions 74 corresponding to the defects 70 and an inspection image defective candidate region 84 corresponding to the non-defective feature 80.

The effects of the image inspection apparatus 200a other than the effects described in the second embodiment are the same as those of the image inspection apparatus 200 according to the first embodiment.

### Third Embodiment

Next, an image inspection apparatus according to a third embodiment will be described.

### Functional Configuration of Processor Included in Image Inspection Apparatus According to Third Embodiment

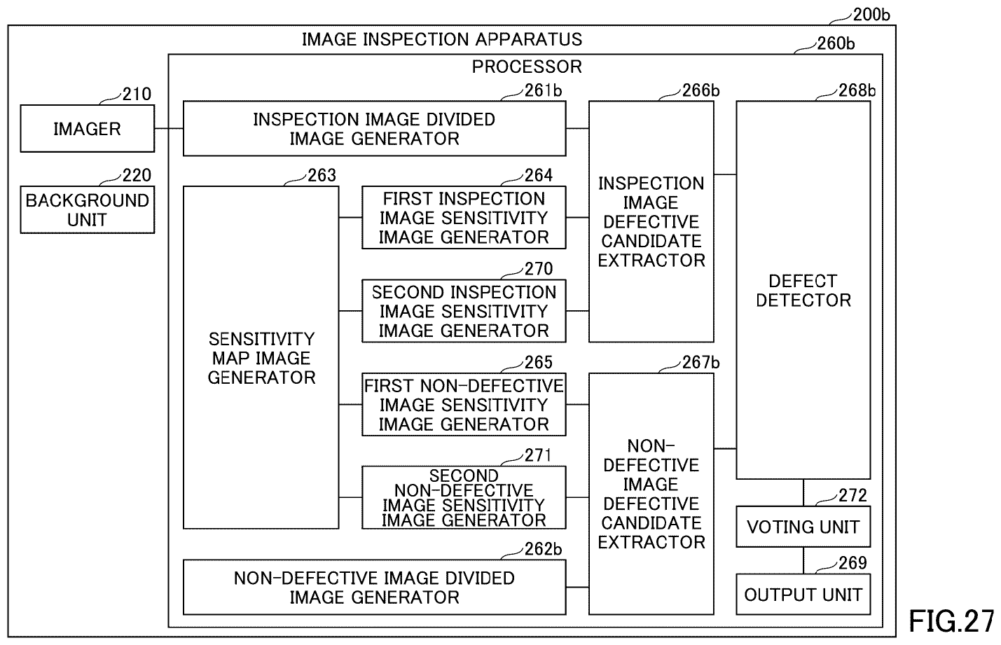

FIG. 27 is a block diagram illustrating an example of a functional configuration of a processor 260b included in an image inspection apparatus 200b according to a third embodiment. The processor 260b includes an inspection image divided image generator 261b, a non-defective image divided image generator 262b, an inspection image defective candidate extractor 266b, a non-defective image defective candidate extractor 267b, a defect detector 268b, and a voting unit 272. The above-described configurations are different from those of the processor 260a in the second embodiment.

These components are functions or functional units that are implemented by operating any of the components illustrated in FIG. 2 in response to a command from the ROM 902a according to a program loaded from the RAM 902b onto the CPU 901.

The inspection image divided image generator 261b receives an image signal including the inspection image captured by the imager 210, and generates N inspection image divided images each obtained by averaging luminance values of pixels in each of a plurality of regions into which the inspection image is divided while changing at least one of phases, directions, and sizes of the plurality of regions. Here, N represents an integer of 2 or more. The inspection image divided image generator 261b can generate, for example, N inspection image divided images having different mosaic roughness in the mosaic-like image.

The non-defective image divided image generator 262b acquires a non-defective image by referring to the HD 909 or the like, and generates N non-defective image divided images each obtained by averaging luminance values of pixels in each of a plurality of regions into which the non-defective image is divided, while changing at least one of the phases, directions, and sizes of the plurality of regions. The non-defective image divided image generator 262b can generate, for example, N non-defective image divided images having different mosaic roughnesses in the mosaic-like image.

The inspection image defective candidate extractor 266b performs a process of comparing luminance values of pixels in an inspection image region of interest with luminance values of pixels in a region around the inspection image region of interest, from among a plurality of regions included in the inspection image divided image, for each of the N inspection image divided images generated by the inspection image divided image generator 261b. The inspection image defective candidate extractor 266b extracts N inspection image defective candidate regions based on the first inspection image threshold generated by the first inspection image sensitivity image generator 264 and the second inspection image threshold generated by the second inspection image sensitivity image generator 270.

The non-defective image defective candidate extractor 267b performs a process of comparing luminance values of pixels in a non-defective image region of interest and luminance values of pixels in a region around the non-defective image region of interest, from among a plurality of regions included in the non-defective image divided image, for each of the N non-defective image divided images generated by the non-defective image divided image generator 262b. The non-defective image defective candidate extractor 267b extracts N non-defective image defective candidate regions based on the first non-defective image threshold generated by the first non-defective image sensitivity image generator 265 and the second non-defective image threshold generated by the second non-defective image sensitivity image generator 271.

The defect detector 268b compares the N inspection image defective candidate regions with the N non-defective image defective candidate regions corresponding to the inspection image defective candidate regions, respectively, and detects N defective regions. The defect detector 268b removes (does not extract), for example, a defective candidate region common to both the inspection image defective candidate region and the non-defective image defective candidate region as a non-defective feature.

The defect detector 268b can detect regions extracted only from the inspection image defective candidate region as N positive defective regions which are present in the inspection image and are not present in the non-defective image. The defect detector 268b can detect regions extracted only from the non-defective image defective candidate region as N negative defective regions which are present in the non-defective image and are not present in the inspection image.

The voting unit 272 generates at least one of an inspection image voting defective region obtained by performing a voting process on N positive defective regions, and a non-defective image voting defective region obtained by performing a voting process on N negative defective regions.

Specifically, the voting unit 272 prepares a positive defect voting space and a negative defect voting space. The voting unit 272 performs a voting process on the N positive defective regions in a positive defect voting space to generate an inspection image voting defective region. Further, the voting unit 272 performs process on the N negative defective regions in a negative defect voting space to generate a non-defective image voting defective region.

The voting process is a process of voting (accumulation) in a voting space set corresponding to the inspection image, with the first defective region and the second defective region as voting source information. The voting space may be configured with the same resolution as the original resolution of the inspection image and the non-defective image, and voting may be performed on a per-pixel basis within the voting space. The voting unit 272 can also perform a weighted voting process of weighting regions according to a predetermined rule during voting.

The voting unit 272 outputs at least one of the inspection image voting defective region and the non-defective image voting defective region as a defect detection result to a device or an apparatus other than the processor 260b such as a personal computer (PC) via the output unit 269.

### Operation Example of Image Inspection Apparatus 200b

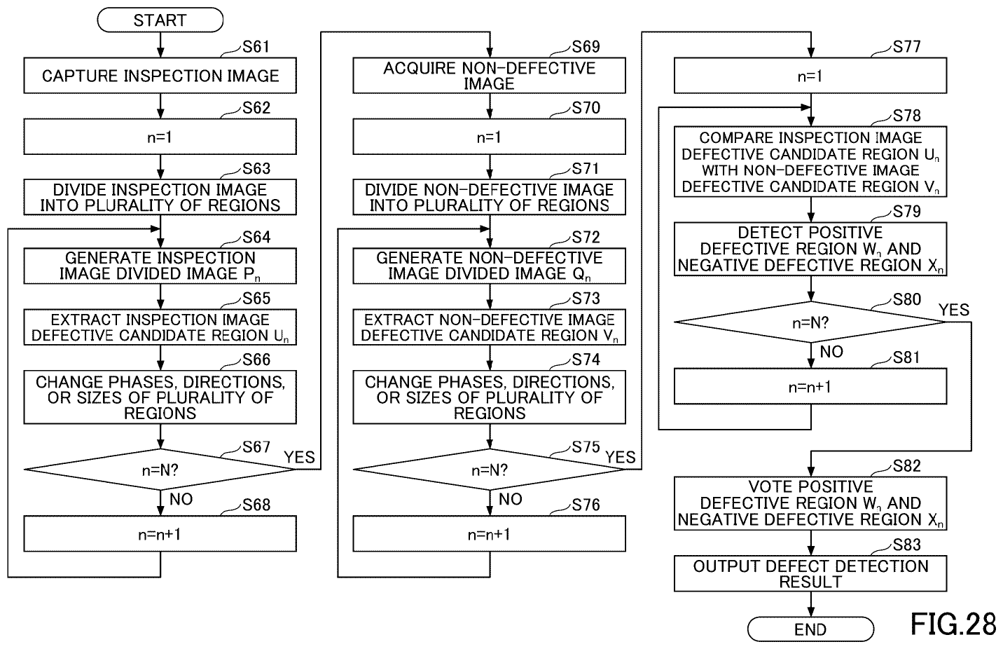

FIG. 28 is a flowchart illustrating an example of an operation of the image inspection apparatus 200b. FIG. 28 illustrates the operation of the image inspection apparatus 200b under the start condition that the inspection object P on which the printed image is formed is sent from the image forming unit 100 to the image inspection apparatus 200b. However, the operation start condition of the image inspection apparatus 200b is not limited to the start condition that the inspection object P is sent from the image forming unit 100 to the image inspection apparatus 200b. For example, the image inspection apparatus 200b may start the operation of FIG. 28 using an operation input for starting inspection performed by a user of the image inspection apparatus 200b or the image forming apparatus 1 using the operation panel 101 as a start condition.

First, in step S61, the image inspection apparatus 200b captures, by the imager 210, a printed image formed on an inspection object P as an inspection image.

Subsequently, in step S62, the image inspection apparatus 200b substitutes 1 into a counter n by the inspection image divided image generator 261b.

Subsequently, in step S63, the image inspection apparatus 200b inputs, by the inspection image divided image generator 261b, an image signal including the inspection image captured by the imager 210 and divides the inspection image into a plurality of regions in a grid-like matrix.

Subsequently, in step S64, the image inspection apparatus 200b generates, by the inspection image divided image generator 261b, an inspection image divided image Pₙ by averaging luminance values of pixels included in each of the plurality of divided regions.

Subsequently, in step S65, the image inspection apparatus 200b extracts, by the inspection image defective candidate extractor 266b, an inspection image defective candidate region Uₙ from the entire inspection image divided image Pₙ.

Subsequently, in step S66, the image inspection apparatus 200b changes, by the inspection image divided image generator 261b, at least one of a phase, direction, and size of each of the plurality of divided regions with respect to the inspection image divided image Pₙ and generates an inspection image divided image Pₙ₊₁ obtained by averaging luminance values of pixels included in each region.

Subsequently, in step S67, the image inspection apparatus 200b determines, by the inspection image divided image generator 261b, whether or not n is equal to N.

When it is determined in step S67 that n is not equal to N (NO in step S67), the image inspection apparatus 200b adds 1 to the counter n in step S68 by the inspection image divided image generator 261b. Thereafter, the image inspection apparatus 200b repeatedly performs the operations in and after step S67 until it is determined in step S67 that n is equal to N.

When it is determined in step S67 that n is equal to N (YES in step S67), in step S69, the image inspection apparatus 200b acquires, by the non-defective image divided image generator 262b, a non-defective image with reference to HD 909 or the like.

Subsequently, in step S70, the image inspection apparatus 200b substitutes 1 into a counter n by the non-defective image divided image generator 262b.

Subsequently, in step S71, the image inspection apparatus 200b divides, by the non-defective image divided image generator 262b, the non-defective image into a plurality of regions in a grid-like matrix.

Subsequently, in step S72, the image inspection apparatus 200b generates, by the non-defective image divided image generator 262b, a non-defective image divided image Qₙ obtained by averaging luminance values of pixels included in each of the plurality of divided regions.

Subsequently, in step S73, the image inspection apparatus 200b extracts, by the non-defective image defective candidate extractor 267b, a non-defective image defective candidate region Vₙ in the entire non-defective image divided image Qₙ.

Subsequently, in step S74, the image inspection apparatus 200b changes, by the non-defective image divided image generator 262b, at least one of a phase, direction, and size of each of the plurality of divided regions with respect to the non-defective image divided image Qₙ and generates a non-defective image divided image Qₙ₊₁ obtained by averaging luminance values of pixels included in each region.

Subsequently, in step S75, the image inspection apparatus 200b determines, by the non-defective image divided image generator 262b, whether or not n is equal to N.

In step S75, when it is determined that n is not equal to N (step S75, NO), in step S76, the image inspection apparatus 200b adds 1 to the counter n by the non-defective image divided image generator 262b. Thereafter, the image inspection apparatus 200b repeatedly performs the operations in and after step S75 until it is determined in step S72 that n is equal to N.

When it is determined in step S75 that n is equal to N (step S75, YES), the image inspection apparatus 200b substitutes 1 for the counter n by the defect detector 268b in step S77.

The operation with respect to the non-defective image from step S69 to step S76 may be performed before the operation with respect to the inspection image from step S61 to step S68, or both operations may be performed in parallel.

Subsequently, in step S78, the image inspection apparatus 200b compares, by the defect detector 268b, the inspection image defective candidate region Uₙ with the non-defective image defective candidate region Vₙ corresponding to the inspection image defective candidate region Uₙ.

Subsequently, in step S79, the image inspection apparatus 200b detects, by the defect detector 268b, the positive defective region Wₙ and the negative defective region Xₙ.

Subsequently, in step S80, the image inspection apparatus 200b determines, by the defect detector 268b, whether or not n is equal to N.

When it is determined in step S80 that n is not equal to N (NO in step S80), the image inspection apparatus 200b adds 1 to the counter n by the defect detector 268b in step S81. Thereafter, the image inspection apparatus 200b repeatedly performs the operations in and after step S80 until it is determined in step S78 that n is equal to N.

When it is determined in step S80 that n is equal to N (YES in step S80), in step S82, the image inspection apparatus 200b generates, by the voting unit 272, at least one of an inspection image voting defective region obtained by voting N positive defective regions Wₙ or a non-defective image voting defective region obtained by voting N negative defective regions Xₙ as a defect detection result.

Subsequently, in step S83, the image apparatus 200b outputs, by the defect inspection detector 268b, the defect detection result of the printed image to an apparatus or a device other than the processor 260b such as a personal computer (PC) via the output unit 269.

In this manner, the image inspection apparatus 200b can detect a defect in the printed image.

<Processing Result by Processor 260b>

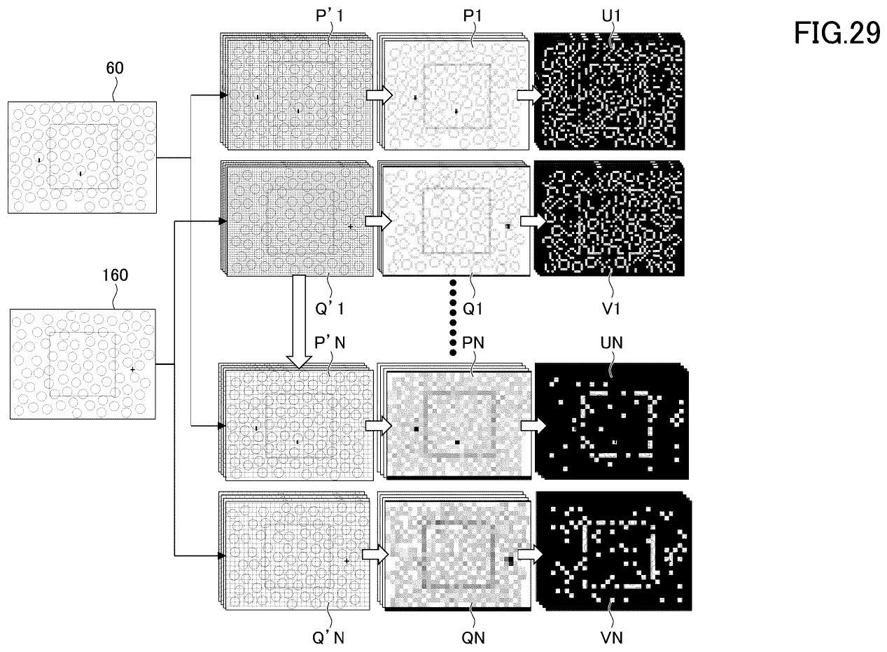

FIG. 29 is a diagram illustrating an example of processing performed by the processor 260b. FIG. 29 illustrates an example of a processing result for each step in which the processor 260b inputs the inspection image 60 illustrated in FIG. 6 and the non-defective image 160 illustrated in FIG. 9 and performs processing.

The inspection image grid-divided images P′₁ to P′_{N} indicate N images obtained by dividing the inspection image 60 by varying the sizes of the grid-like regions. The non-defective image grid-divided images Q′₁ to Q′_{N} indicate N images obtained by dividing the non-defective image 160 by varying the sizes of the grid-like regions.

The inspection image divided images P₁ to P_{N} indicate N images obtained by changing at least one of the phases or the directions of the grid-like regions in the inspection image grid-divided images P′₁ to P′_{N}. The non-defective image divided images Q₁ to Q_{N} indicate N images obtained by changing at least one of the phases or the directions of the grid-like regions in the non-defective image grid divided images Q′₁ to Q′_{N}.

The inspection image defective candidate regions U₁ to U_{N} indicate inspection image defective candidate regions extracted from the inspection image divided images P₁ to P_{N}, respectively. The non-defective image defect candidate regions V₁ to V_{N} indicate the non-defective image defect candidate regions extracted from the non-defective image divided images Q₁ to Q_{N}, respectively.

By comparing the inspection image defective candidate regions U₁ to U_{N} with the non-defective image defective candidate regions V₁ to V_{N} corresponding to the inspection image defective candidate regions U₁ to U_{N}, respectively, at least one of the positive defective regions W₁ to W_{N} and the negative defective regions X₁ to X_{N} can be detected.

The image inspection apparatus 200a illustrated in the second embodiment corresponds to the case of N=2 in the image inspection apparatus 200b. Specifically, the first inspection image processed image 61 in FIG. 7 corresponds to the inspection image divided image P₁ in the case of n=1, and the second inspection image processed image 62 in FIG. 25 corresponds to the inspection image divided image P₂ in the case of n=2. The inspection image defective candidate region image 63 in FIG. 8 corresponds to the inspection image defective candidate region U₁. The inspection image defective candidate region image 64 in FIG. 26 corresponds to the inspection image defective candidate region U₂.

Similarly, the first non-defective image processed image 161 in FIG. 10 corresponds to the non-defective image divided image Q₁ in the case of n=1. The second non-defective image divided image corresponds to the non-defective image divided image Q₂ in the case of n=2. The non-defective image defective candidate region image 163 in FIG. 11 corresponds to the non-defective image defective candidate region V₁.

The inspection image defective candidate extractor 266b generates N inspection image divided images P₁ to P_{N} including examples of the first inspection image processed image 61 or the second inspection image processed image 62, and extracts N inspection image defective candidate regions U₁ to U_{N} including examples of the inspection image defective candidate region images 63 and 64. The non-defective image defective candidate extractor 267b generates N non-defective image divided images Q₁ to ON including the example of the first non-defective image processed image 161, and extracts N non-defective image defective candidate regions V₁ to V_{N} including the example of the non-defective image defective candidate region image 163. Based on these results, the defect detector 268b detects at least one of the positive defective regions W₁ to W_{N} and the negative defective regions X₁ to X_{N}.

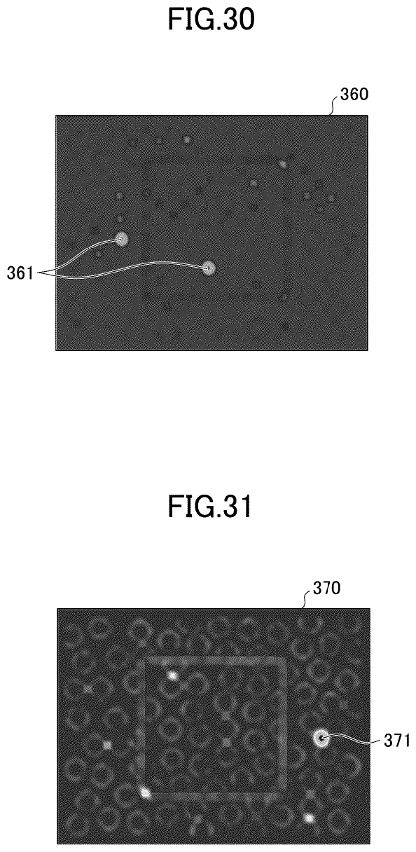

FIG. 30 is a diagram illustrating an example of an inspection image voting defective region 360 in the image inspection apparatus 200b. FIG. 31 is a diagram illustrating an example of a non-defective image voting defective region 370 in the image inspection apparatus 200b.

The inspection image voting defective region 360 illustrated in FIG. 30 is displayed by performing the voting process on the positive defective regions W₁ to W_{N} and normalizing the accumulated luminance values of the pixels obtained by the voting process. Positive defects 361 are clearly detected.

The non-defective image voting defective region 370 illustrated in FIG. 31 is displayed by performing the voting process on the negative defective regions X₁ to X_{N} and normalizing the accumulated luminance values of the pixels obtained by the voting process. A negative defect 371 is clearly detected.

### Effects of Image Inspection Apparatus 200b

As described above, in the present embodiment, at least one of the inspection image voting defective region 360 obtained by voting the N positive defective regions W₁ to W_{N} and the non-defective image voting defective region 370 obtained by voting the N negative defective regions X₁ to X_{N} is generated.

By performing the voting process, the positive defects detected in common in the N positive defective regions W₁ to W_{N} are accumulated and the luminance values of the pixels become larger than those of the other regions, and therefore, the positive defects become more conspicuous. Similarly, the negative defects detected in common in the N negative defective regions X₁ to X_{N} are accumulated and the luminance values of the pixels become larger than those of the other regions, and therefore, the negative defects become more conspicuous. Thus, the false defect detection is prevented, and the defects can be detected with high accuracy.

In the present embodiment, an example in which the voting process is performed on the N positive defective regions W₁ to W_{N} and the N negative defective regions X₁ to X_{N} has been described, but the present disclosure is not limited to the above-described example. One of the N positive defective regions W₁ to W_{N} may be selected as a positive defect detection result, or one of the N negative defective regions X₁ to X_{N} may be selected as a negative defect detection result.

For example, in a case where N positive defective regions W₁ to W_{N} and N negative defective regions X₁ to X_{N} are detected by varying the size of a plurality of regions, the smaller the region size, the higher the resolution. In this case, recording media with a large surface roughness of the base material, such as plain paper, are prone to false detection of the base material as a defective region. Therefore, selecting positive defect region Wₙ or negative defect region Xₙ, where the region size is large and the resolution is low, can suitably prevent false detections.

Conversely, recording media with a small surface roughness of the base material, such as glossy paper, are less likely to be falsely detected as a defective region. Therefore, selecting positive defect region Wₙ or negative defect region Xₙ, where the region size is smaller and the resolution is higher, increases the resolution and allows detection of smaller defects.

Thus, appropriate defect detection can be performed according to the characteristics of the inspection object by selectively using either the positive defective region Wₙ or the negative defective region Xₙ.

The effects of the image inspection apparatus 200b other than the effects described in the third embodiment are the same as those of the image inspection apparatus 200 according to the first embodiment.

Although the embodiments have been described above, the present disclosure is not limited to the embodiments specifically disclosed above, and various modifications and changes can be made without departing from the scope of the claims.

In the above-described embodiments, the printed image formed by the electrophotographic process is exemplified, but the image inspection apparatus according to the embodiments can be applied to a printed image formed by another process such as an inkjet process.

The image inspection apparatus according to the embodiments is an apparatus that performs inspection based on an image (inspection image) of an inspection object, and the inspection object is not limited to an image such as a printed image. For example, a component or the like may be used as the inspection object.

It should be understood that the ordinal numbers, quantities, and other numerical values used herein are provided solely for illustrative purposes in order to facilitate a concrete understanding of the present disclosure, and are not intended to limit the scope of the invention in any way. It should also be understood that the connections between the constituent elements described herein are provided solely by way of example for the purpose of concretely illustrating the present disclosure, and that the invention is not limited to such exemplary connections, insofar as other connection configurations may achieve the functions of the present disclosure.

Each function of the above-described embodiments can be implemented by one or more processing circuits. Here, the “processing circuit” in the present specification includes a processor programmed to execute each function by software, such as a processor implemented by an electronic circuit, and a device such as an application specific integrated circuit (ASIC), a digital signal processor (DSP), a field programmable gate array (FPGA), or a conventional circuit module designed to execute each function described above.

The aspects of the present disclosure are as follows, for example.

<1>

An image inspection apparatus for inspecting a defect of an inspection object, the image inspection apparatus including:
an imager configured to capture an inspection image of the inspection object; and
a processor configured to process the inspection image captured by the imager,
wherein the processing the inspection image includes:
   an inspection image divided image generator configured to generate an inspection image divided image using a first inspection image processed image, the first inspection image processed image being obtained by averaging luminance values of pixels in each of a plurality of processing regions into which the inspection image is divided under a predetermined first inspection image dividing condition;
   a non-defective image divided image generator configured to generate a non-defective image divided image using a first non-defective image processed image, the first non-defective image processed image being obtained by averaging luminance values of pixels in each of a plurality of processing regions into which a non-defective image to be compared with the inspection image is divided under a predetermined first non-defective image dividing condition;
   a sensitivity map image generator configured to generate a sensitivity map image which has a same size as the inspection image and the non-defective image and in which a detection threshold is set for each predetermined detection region;
   a first inspection image sensitivity image generator configured to divide the sensitivity map image into a plurality of regions according to the first inspection image dividing condition, and generate a first inspection image sensitivity image by processing a first inspection image threshold of each region according to the detection threshold;
   a first non-defective image sensitivity image generator configured to divide the sensitivity map image into a plurality of regions according to the first non-defective image dividing condition, and generate a first non-defective image sensitivity image by processing a first non-defective image threshold of each region according to the detection threshold;
   an inspection image defect candidate extractor configured to compare luminance values of pixels in an inspection image region of interest with luminance values of pixels in a processing region around the inspection image region of interest, from among a plurality of processing regions included in the inspection image divided image, and extract an inspection image defect candidate region based on the first inspection image threshold;
   a non-defective image defect candidate extractor configured to compare luminance values of pixels in a non-defective image region of interest with luminance values of pixels in a processing region around the non-defective image region of interest, from among a plurality of processing regions included in the non-defective image divided image, and extract a non-defective image defect candidate region based on the first non-defective image threshold; and
   a defect detector configured to compare the inspection image defect candidate region with the non-defective image defect candidate region to detect a defective region.
      <2>

An image inspection apparatus for inspecting a defect of an inspection object, the image inspection apparatus including:
an imager configured to capture an inspection image of the inspection object; and
a processor configured to process the inspection image captured by the imager,
wherein the processing the inspection image includes:
   an inspection image divided image generator configured to generate an inspection image divided image using at least one of a first inspection image processed image or a second inspection image processed image, the first inspection image processed image being obtained by averaging luminance values of pixels in each of a plurality of processing regions into which the inspection image is divided under a predetermined first inspection image dividing condition, and the second inspection image processed image being obtained by averaging luminance values of pixels in each of a plurality of processing regions into which the inspection image is divided under a second inspection image dividing condition in which at least one of a phase, a direction, or a size differs from that of the first inspection image dividing condition;
   a non-defective image divided image generator configured to generate a non-defective image divided image using at least one of a first non-defective image processed image or a second non-defective image processed image, the first non-defective image processed image being obtained by averaging luminance values of pixels in each of a plurality of processing regions into which a non-defective image to be compared with the inspection image is divided under a predetermined first non-defective image dividing condition, and the second non-defective image processed image being obtained by averaging luminance values of pixels in each of a plurality of processing regions into which the non-defective image is divided under a second non-defective image dividing condition in which at least one of a phase, a direction, or a size differs from that of the first non-defective image dividing condition;
   a sensitivity map image generator configured to generate a sensitivity map image which has a same size as the inspection image and the non-defective image and in which a detection threshold is set for each predetermined detection region;
   a first inspection image sensitivity image generator configured to divide the sensitivity map image into a plurality of regions according to the first inspection image dividing condition, and generate a first inspection image sensitivity image by processing a first inspection image threshold included in each region according to the detection threshold;
   a first non-defective image sensitivity image generator configured to divide the sensitivity map image into a plurality of regions according to the first non-defective image dividing condition, and generate a first non-defective image sensitivity image by processing a first non-defective image threshold included in each region according to the detection threshold;
   a second inspection image sensitivity image generator configured to divide the sensitivity map image into a plurality of regions according to the second inspection image dividing condition, and generate a second inspection image sensitivity image by processing a second inspection image threshold included in each region according to the detection threshold;
a second non-defective image sensitivity image generator configured to divide the sensitivity map image into a plurality of regions according to the second non-defective image dividing condition, and generate a second non-defective image sensitivity image by processing a second non-defective image threshold included in each region according to the detection threshold;
   an inspection image defect candidate extractor configured to compare luminance values of pixels in an inspection image region of interest with luminance values of pixels in a processing region around the inspection image region of interest, from among a plurality of processing regions included in the inspection image divided image, and extract an inspection image defect candidate region based on the first inspection image threshold and the second inspection image threshold;
   a non-defective image defect candidate extractor configured to compare luminance values of pixels in a non-defective image region of interest with luminance values of pixels in a processing region around the non-defective image region of interest, from among a plurality of processing regions included in the non-defective image divided image, and extract a non-defective image defect candidate region based on the first non-defective image threshold and the second non-defective image threshold; and
   a defect detector configured to compare the inspection image defect candidate region with the non-defective image defect candidate region to detect a defective region.
      <3>

The image inspection apparatus according to <1> or <2>, wherein the detection threshold is set according to any one of:
a luminance value of the inspection image;
a difference in luminance between pixels of the inspection image region of interest and pixels of the processing region around the inspection image region of interest, from among a plurality of processing regions included in the inspection image divided image; and
an input by a user of the image inspection apparatus.
   <4>

The image inspection apparatus according to any one of <1> to <3>, wherein the non-defective image is an image obtained by imaging the inspection object having no defect.

<5>

The image inspection apparatus according to any one of <1> to <3>, wherein the non-defective image is a digital master image generated based on image data serving as a source of the inspection image.

<6>

The image inspection apparatus according to <1>, wherein the first inspection image sensitivity image generator calculates the first inspection image threshold by a mathematical expression based on the detection threshold, and the first non-defective image sensitivity image generator calculates the first non-defective image threshold by a mathematical expression based on the detection threshold.

<7>

The image inspection apparatus according to <2>, wherein the first inspection image sensitivity image generator calculates the first inspection image threshold by a mathematical expression based on the detection threshold,
the first non-defective image sensitivity image generator calculates the first non-defective image threshold by a mathematical expression based on the detection threshold,
the second inspection image sensitivity image generator calculates the second inspection image threshold by a mathematical expression based on the detection threshold, and
the second non-defective image sensitivity image generator calculates the second non-defective image threshold by a mathematical expression based on the detection threshold.
   <8>

An image forming apparatus comprising the image inspection apparatus according to any one of <1> to <7>.

<9>

An image inspection method for inspecting a defect of an inspection object, the image inspection method being performed by an image inspection apparatus, the image inspection method including:
capturing, by an imager, an inspection image of the inspection object; and
processing, by a processor, the inspection image captured by the imager,
wherein the processing the inspection image includes:
   generating, by an inspection image divided image generator, an inspection image divided image using a first inspection image processed image, the first inspection image processed image being obtained by averaging luminance values of pixels in each of a plurality of processing regions into which the inspection image is divided under a predetermined first inspection image dividing condition;
   generating, by a non-defective image divided image generator, a non-defective image divided image using a first non-defective image processed image, the first non-defective image processed image being obtained by averaging luminance values of pixels in each of a plurality of processing regions into which a non-defective image to be compared with the inspection image is divided under a predetermined first non-defective image dividing condition;
   generating, by a sensitivity map image generator, a sensitivity map image which has a same size as the inspection image and the non-defective image and in which a detection threshold is set for each predetermined detection region;
   dividing, by a first inspection image sensitivity image generator, the sensitivity map image into a plurality of regions according to the first inspection image dividing condition, and generating a first inspection image sensitivity image by processing a first inspection image threshold of each region according to the detection threshold;
   dividing, by a first non-defective image sensitivity image generator, the sensitivity map image into a plurality of regions according to the first non-defective image dividing condition, and generating a first non-defective image sensitivity image by processing a first non-defective image threshold of each region according to the detection threshold;
   comparing, by an inspection image defect candidate extractor, luminance values of pixels in an inspection image region of interest with luminance values of pixels in a processing region around the inspection image region of interest, from among a plurality of processing regions included in the inspection image divided image, and extracting an inspection image defect candidate region based on the first inspection image threshold;
   comparing, by a non-defective image defect candidate extractor, luminance values of pixels in a non-defective image region of interest with luminance values of pixels in a processing region around the non-defective image region of interest, from among a plurality of processing regions included in the non-defective image divided image, and extracting a non-defective image defect candidate region based on the first non-defective image threshold; and
   comparing, by a defect detector, the inspection image defect candidate region with the non-defective image defect candidate region to detect a defective region.

What is claimed is:

1. An image inspection apparatus for inspecting a defect of an inspection object, the image inspection apparatus comprising:
an imager configured to capture an inspection image of the inspection object;
a memory storing programs having computer-readable instructions; and
a processor configured to process the inspection image captured by the imager,
wherein the processing the inspection image by the processor includes:
generating an inspection image divided image using a first inspection image processed image, the first inspection image processed image being obtained by averaging luminance values of pixels in each of a plurality of processing regions into which the inspection image is divided under a predetermined first inspection image dividing condition;
generating a non-defective image divided image using a first non-defective image processed image, the first non-defective image processed image being obtained by averaging luminance values of pixels in each of a plurality of processing regions into which a non-defective image to be compared with the inspection image is divided under a predetermined first non-defective image dividing condition;
generating a sensitivity map image which has a same size as the inspection image and the non-defective image and in which a detection threshold is set for each predetermined detection region;
dividing the sensitivity map image into a plurality of regions according to the first inspection image dividing condition, and generating a first inspection image sensitivity image by processing a first inspection image threshold of each region according to the detection threshold;
dividing the sensitivity map image into a plurality of regions according to the first non-defective image dividing condition, and generating a first non-defective image sensitivity image by processing a first non-defective image threshold of each region according to the detection threshold;
comparing luminance values of pixels in an inspection image region of interest with luminance values of pixels in a processing region around the inspection image region of interest, from among a plurality of processing regions included in the inspection image divided image, and extracting an inspection image defect candidate region based on the first inspection image threshold;
comparing luminance values of pixels in a non-defective image region of interest with luminance values of pixels in a processing region around the non-defective image region of interest, from among a plurality of processing regions included in the non-defective image divided image, and extracting a non-defective image defect candidate region based on the first non-defective image threshold; and
comparing the inspection image defect candidate region with the non-defective image defect candidate region to detect a defective region.

2. An image inspection apparatus for inspecting a defect of an inspection object, the image inspection apparatus comprising:
an imager configured to capture an inspection image of the inspection object;
a memory storing programs having computer-readable instructions; and
a processor configured to process the inspection image captured by the imager,
wherein the processing the inspection image by the processor includes:
generating an inspection image divided image using at least one of a first inspection image processed image or a second inspection image processed image, the first inspection image processed image being obtained by averaging luminance values of pixels in each of a plurality of processing regions into which the inspection image is divided under a predetermined first inspection image dividing condition, and the second inspection image processed image being obtained by averaging luminance values of pixels in each of a plurality of processing regions into which the inspection image is divided under a second inspection image dividing condition in which at least one of a phase, a direction, or a size differs from that of the first inspection image dividing condition;
generating a non-defective image divided image using at least one of a first non-defective image processed image or a second non-defective image processed image, the first non-defective image processed image being obtained by averaging luminance values of pixels in each of a plurality of processing regions into which a non-defective image to be compared with the inspection image is divided under a predetermined first non-defective image dividing condition, and the second non-defective image processed image being obtained by averaging luminance values of pixels in each of a plurality of processing regions into which the non-defective image is divided under a second non-defective image dividing condition in which at least one of a phase, a direction, or a size differs from that of the first non-defective image dividing condition;
generating a sensitivity map image which has a same size as the inspection image and the non-defective image and in which a detection threshold is set for each predetermined detection region;
dividing the sensitivity map image into a plurality of regions according to the first inspection image dividing condition, and generating a first inspection image sensitivity image by processing a first inspection image threshold included in each region according to the detection threshold;
dividing the sensitivity map image into a plurality of regions according to the first non-defective image dividing condition, and generating a first non-defective image sensitivity by image processing a first non-defective image threshold included in each region according to the detection threshold;
dividing the sensitivity map image into a plurality of regions according to the second inspection image dividing condition, and generating a second inspection image sensitivity image by processing a second inspection image threshold included in each region according to the detection threshold;
dividing the sensitivity map image into a plurality of regions according to the second non-defective image dividing condition, and generating a second non-defective image sensitivity image by processing a second non-defective image threshold included in each region according to the detection threshold;
comparing luminance values of pixels in an inspection image region of interest with luminance values of pixels in a processing region around the inspection image region of interest, from among a plurality of processing regions included the inspection image divided image, and extracting an inspection image defect candidate region based on the first inspection image threshold and the second inspection image threshold;
comparing luminance values of pixels in a non-defective image region of interest with luminance values of pixels in a processing region around the non-defective image region of interest, from among a plurality of processing regions included in the non-defective image divided image, and extracting a non-defective image defect candidate region based on the first non-defective image threshold and the second non-defective image threshold; and
comparing the inspection image defect candidate region with the non-defective image defect candidate region to detect a defective region.

3. The image inspection apparatus according to claim 1, wherein the detection threshold is set according to any one of:
a luminance value of the inspection image;
a difference in luminance between pixels of the inspection image region of interest and pixels of the processing region around the inspection image region of interest, from among a plurality of processing regions included in the inspection image divided image; and
an input by a user of the image inspection apparatus.

4. The image inspection apparatus according to claim 1, wherein the non-defective image is an image obtained by imaging the inspection object having no defect.

5. The image inspection apparatus according to claim 1, wherein the non-defective image is a digital master image generated based on image data serving as a source of the inspection image.

6. The image inspection apparatus according to claim 1, wherein the first inspection image threshold is calculated by a mathematical expression based on the detection threshold, and the first non-image threshold is calculated by a defective mathematical expression based on the detection threshold.

7. The image inspection apparatus according to claim 2, wherein the first inspection image threshold is calculated by a mathematical expression based on the detection threshold,
the first non-defective image threshold is calculated by a mathematical expression based on the detection threshold,
the second inspection image threshold is calculated by a mathematical expression based on the detection threshold, and
the second non-defective image threshold is calculated by a mathematical expression based on the detection threshold.

8. An image forming apparatus comprising the image inspection apparatus according to claim 1.

9. An image inspection method for inspecting a defect of an inspection object performed by an image inspection apparatus, the image inspection apparatus including an imager configured to capture an inspection image of the inspection object, a memory storing programs having computer-readable instructions, and a processor configured to process the inspection image captured by the imager, the image inspection method comprising:
capturing, by the imager, an inspection image of the inspection object; and
processing, by the processor, the inspection image captured by the imager, wherein the processing the inspection image by the processor includes:
generating an inspection image divided image using a first inspection image processed image, the first inspection image processed image being obtained by averaging luminance values of pixels in each of a plurality of processing regions into which the inspection image is divided under a predetermined first inspection image dividing condition;
generating a non-defective image divided image using a first non-defective image processed image, the first non-defective image processed image being obtained by averaging luminance values of pixels in each of a plurality of processing regions into which a non-defective image to be compared with the inspection image is divided under a predetermined first non-defective image dividing condition;
generating a sensitivity map image which has a same size as the inspection image and the non-defective image and in which a detection threshold is set for each predetermined detection region;
dividing the sensitivity map image into a plurality of regions according to the first inspection image dividing condition, and generating a first inspection image sensitivity image by processing a first inspection image threshold of each region according to the detection threshold;
dividing the sensitivity map image into a plurality of regions according to the first non-defective image dividing condition, and generating a first non-defective image sensitivity image by processing a first non-defective image threshold of each region according to the detection threshold;
comparing luminance values of pixels in an inspection image region of interest with luminance values of pixels in a processing region around the inspection image region of interest, from among a plurality of processing regions included in the inspection image divided image, and extracting an inspection image defect candidate region based on the first inspection image threshold;
comparing luminance values of pixels in a non-defective image region of interest with luminance values of pixels in a processing region around the non-defective image region of interest, from among a plurality of processing regions included in the non-defective image divided image, and extracting a non-defective image defect candidate region based on the first non-defective image threshold; and
comparing the inspection image defect candidate region with the non-defective image defect candidate region to detect a defective region.
